(19) United States
(12) Patent Application Publication
(10) Pub. No.: US 2026/0270013 A1
(43) Pub. Date: Sep. 10, 2026

(54) UNIFIED TRANSMISSION CONFIGURATION INDICATION DETERMINATION FOR SINGLE FREQUENCY NETWORK

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/881,560

(22) PCT Filed: Aug. 11, 2022
(86) PCT No.: PCT/CN2022/111703

§ 371 Date: Jan. 6, 2025

(51) Int. Cl. H04L 5/00

(52) U.S. Cl. CPC H04L 5/0053

(57) ABSTRACT

Methods, systems, and devices for wireless communications are described. A user equipment (UE) may communicate with the network via two or more transmission reception points (TRPs). Described techniques relate to determining which unified transmission configuration indication (TCI) state to apply to a communication on a channel configured for single frequency network (SFN) operations based on one or more conditions. For example, a UE may receive control signaling identifying a configuration of the UE to communicate with a first TRP and a second TRP using an SFN operation for at least one channel. The UE may receive control signaling indicating a unified TCI state for the at least one channel. The UE may determine whether to apply the indicated unified TCI state to a communication (e.g., transmission of or reception of a signal) on the channel configured according to the SFN operation based on one or more conditions.

### CROSS REFERENCE

The present Application is a 371 national stage filing of International PCT Application No. PCT/CN2022/111703 by Yuan et al. entitled “UNIFIED TRANSMISSION CONFIGURATION INDICATION DETERMINATION FOR SINGLE FREQUENCY NETWORK,” filed Aug. 11, 2022, which is assigned to the assignee hereof, and which is expressly incorporated by reference in its entirety herein.

### FIELD OF TECHNOLOGY

The following relates to wireless communications, including unified transmission configuration indication determination for single frequency network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support unified transmission configuration indication (TCI) determination for single frequency network (SFN). A user equipment (UE) may communicate with the network via two or more transmission reception points (TRP) s. A UE may be configured to communicate via an SFN configuration. Some wireless communications systems may apply unified TCI states. Described techniques relate to determining which unified TCI state to apply to a communication on a channel configured for SFN operations based on one or more conditions. For example, a UE may receive control signaling identifying a configuration of the UE to communicate with a first TRP and a second TRP using SFN operation for at least one channel. The UE may receive control signaling indicating a unified TCI state that identifies a beam at the UE that is applicable to more than one channel including the at least one channel configured according to the SFN operation. The UE may determine whether to apply the indicated unified TCI state (e.g., or a default beam, for example as opposed to the unified TCI state) to a communication (e.g., transmission of a signal or reception of a signal) on the channel configured according to the SFN operation based on one or more conditions.

A method for wireless communication at a UE is described. The method may include receiving first control signaling identifying a configuration of the UE to communicate with a first TRP and a second TRP using SFN communications for at least one channel, receiving second control signaling indicating that the UE is to use a unified TCI state that identifies that a single beam at the UE is applicable to a set of multiple channels, including the at least one channel, and communicating on the at least one channel according to at least one beam based on determining, according to one or more conditions, whether to apply the unified TCI state to the at least one channel.

An apparatus for wireless communication is described. The apparatus may include a memory, a transceiver, and at least one processor of a UE, the at least one processor coupled with the memory and the transceiver. The at least one processor may be configured to receive first control signaling identifying a configuration of the UE to communicate with a first TRP and a second TRP using SFN communications for at least one channel, receive second control signaling indicating that the UE is to use a unified TCI state that identifies that a single beam at the UE is applicable to a set of multiple channels, including the at least one channel, and communicate on the at least one channel according to at least one beam based on determining, according to one or more conditions, whether to apply the unified TCI state to the at least one channel.

Another apparatus for wireless communication at a UE is described. The apparatus may include means for receiving first control signaling identifying a configuration of the UE to communicate with a first TRP and a second TRP using SFN communications for at least one channel, means for receiving second control signaling indicating that the UE is to use a unified TCI state that identifies that a single beam at the UE is applicable to a set of multiple channels, including the at least one channel, and means for communicating on the at least one channel according to at least one beam based on determining, according to one or more conditions, whether to apply the unified TCI state to the at least one channel.

A non-transitory computer-readable medium storing code for wireless communication at a UE is described. The code may include instructions executable by a processor to receive first control signaling identifying a configuration of the UE to communicate with a first TRP and a second TRP using SFN communications for at least one channel, receive second control signaling indicating that the UE is to use a unified TCI state that identifies that a single beam at the UE is applicable to a set of multiple channels, including the at least one channel, and communicate on the at least one channel according to at least one beam based on determining, according to one or more conditions, whether to apply the unified TCI state to the at least one channel.

In some examples of the method, apparatuses, and non-transitory computer-readable medium described herein, the one or more conditions include a time threshold, and communicating on the at least one channel may include operations, features, means, or instructions for communicating on the at least one channel according to the unified TCI state based on a time for communication on the at least one channel satisfying the time threshold.

In some examples of the method, apparatuses, and non-transitory computer-readable medium described herein, the one or more conditions include a time threshold, and communicating on the at least one channel may include operations, features, means, or instructions for communicating on the at least one channel according to a default beam based on a time for communication on the at least one channel satisfying the time threshold.

Some examples of the method, apparatuses, and non-transitory computer-readable medium described herein, where the one or more conditions include whether SFN operation is configured at the UE for a downlink control channel, may further include operations, features, means, or instructions for determining whether to apply the unified TCI state to the at least one channel based on the SFN operation being configured for the downlink control channel.

Some examples of the method, apparatuses, and non-transitory computer-readable medium described herein, where the one or more conditions include whether SFN operation is configured at the UE for at least one of a downlink shared channel, an uplink control channel, or an uplink shared channel, may further include operations, features, means, or instructions for determining whether to apply the unified TCI state to the at least one channel based on the SFN operation being configured for the at least one of the downlink shared channel, the uplink control channel, or the uplink shared channel.

Some examples of the method, apparatuses, and non-transitory computer-readable medium described herein, where the one or more conditions include one of intra-cell beam management or inter-cell beam management being configured at the UE, may further include operations, features, means, or instructions for determining whether to apply the unified TCI state to the at least one channel based on the one of the intra-cell beam management or the inter-cell beam management that may be configured at the UE.

Some examples of the method, apparatuses, and non-transitory computer-readable medium described herein, where the one or more conditions include one of a single unified TCI state or two unified TCI states having been indicated to the UE, may further include operations, features, means, or instructions for receiving a control message indicating the one of the single unified TCI state or the two unified TCI states and determining whether to apply the unified TCI state to the at least one channel based on the one of the single unified TCI state or the two unified TCI states being indicated to the UE.

Some examples of the method, apparatuses, and non-transitory computer-readable medium described herein, where the one or more conditions include whether a single default beam is supported by the UE or a plurality of default beams are supported by the UE, may further include operations, features, means, or instructions for determining whether to apply the unified TCI state to the at least one channel based on the single default beam being supported by the UE or the set of multiple default beams being supported by the UE.

Some examples of the method, apparatuses, and non-transitory computer-readable medium described herein may further include operations, features, means, or instructions for receiving third control signaling indicating to enable the UE to use a set of multiple default beams and determining to apply the set of multiple default beams for the at least one channel based on the UE having received the third control signaling enabling the UE to use the set of multiple default beams.

In some examples of the method, apparatuses, and non-transitory computer-readable medium described herein, the second control signaling includes a downlink control information message.

In some examples of the method, apparatuses, and non-transitory computer-readable medium described herein, the at least one channel includes at a physical downlink control channel, a physical downlink shared channel, a physical uplink control channel, a physical uplink shared channel, or any combination thereof.

A method for wireless communication at a network entity is described. The method may include outputting first control signaling identifying a configuration for a UE to use to communicate, using SFN communications for at least one channel, with a first TRP and a second TRP associated with the network entity, outputting second control signaling indicating that the UE is to use a unified TCI state that identifies that a single beam at the UE is applicable to a set of multiple channels, including the at least one channel, and communicating on the at least one channel according to at least one beam based on determining, according to one or more conditions, whether the UE is to apply the unified TCI state to the at least one channel.

An apparatus for wireless communication is described. The apparatus may include a memory and at least one processor of a network entity, the at least one processor coupled with the memory. The at least one processor may be configured to output first control signaling identifying a configuration for a UE to use to communicate, using SFN communications for at least one channel, with a first TRP and a second TRP associated with the network entity, output second control signaling indicating that the UE is to use a unified TCI state that identifies that a single beam at the UE is applicable to a set of multiple channels, including the at least one channel, and communicate on the at least one channel according to at least one beam based on determining, according to one or more conditions, whether the UE is to apply the unified TCI state to the at least one channel.

Another apparatus for wireless communication at a network entity is described. The apparatus may include means for outputting first control signaling identifying a configuration for a UE to use to communicate, using SFN communications for at least one channel, with a first TRP and a second TRP associated with the network entity, means for outputting second control signaling indicating that the UE is to use a unified TCI state that identifies that a single beam at the UE is applicable to a set of multiple channels, including the at least one channel, and means for communicating on the at least one channel according to at least one beam based on determining, according to one or more conditions, whether the UE is to apply the unified TCI state to the at least one channel.

A non-transitory computer-readable medium storing code for wireless communication at a network entity is described. The code may include instructions executable by a processor to output first control signaling identifying a configuration for a UE to use to communicate, using SFN communications for at least one channel, with a first TRP and a second TRP associated with the network entity, output second control signaling indicating that the UE is to use a unified TCI state that identifies that a single beam at the UE is applicable to a set of multiple channels, including the at least one channel, and communicate on the at least one channel according to at least one beam based on determining, according to one or more conditions, whether the UE is to apply the unified TCI state to the at least one channel.

In some examples of the method, apparatuses, and non-transitory computer-readable medium described herein, the one or more conditions include a time threshold, and communicating on the at least one channel may include operations, features, means, or instructions for communicating on the at least one channel according to the unified TCI state based on a time for communication on the at least one channel satisfying the time threshold.

In some examples of the method, apparatuses, and non-transitory computer-readable medium described herein, the one or more conditions include a time threshold, and communicating on the at least one channel may include operations, features, means, or instructions for communicating on the at least one channel according to a default beam based on a time for communication on the at least one channel satisfying the time threshold.

In some examples of the method, apparatuses, and non-transitory computer-readable medium described herein, the one or more conditions include whether SFN operation may be configured at the UE for a downlink control channel.

In some examples of the method, apparatuses, and non-transitory computer-readable medium described herein, the one or more conditions include whether SFN operation may be configured at the UE for at least one of a downlink shared channel.

In some examples of the method, apparatuses, and non-transitory computer-readable medium described herein, the one or more conditions include one of intra-cell beam management or inter-cell beam management being configured at the UE.

Some examples of the method, apparatuses, and non-transitory computer-readable medium described herein, where the one or more conditions include one of a single unified TCI state or two unified TCI states having been indicated to the UE may further include operations, features, means, or instructions for outputting a control message indicating the one of the single unified TCI state or the two unified TCI states.

In some examples of the method, apparatuses, and non-transitory computer-readable medium described herein, the one or more conditions include whether a single default beam may be supported by the UE or a set of multiple default beams may be supported by the UE.

Some examples of the method, apparatuses, and non-transitory computer-readable medium described herein may further include operations, features, means, or instructions for outputting third control signaling to enable the UE to use a set of multiple default beams, where the UE determines to apply the set of multiple default beams for the at least one channel based on the UE having received the third control signaling enabling the UE to use the set of multiple default beams.

### BRIEF DESCRIPTION OF THE DRAWINGS

FIG. 1 illustrates an example of a wireless communications system that supports unified transmission configuration indication (TCI) determination for single frequency network (SFN) in accordance with one or more aspects of the present disclosure.

FIG. 2 illustrates an example of a network architecture that supports unified TCI determination for SFN in accordance with one or more aspects of the present disclosure.

FIG. 3 illustrates an example of a wireless communications system that supports unified TCI determination for SFN in accordance with one or more aspects of the present disclosure.

FIG. 4 illustrates an example of a timing diagram that supports unified TCI determination for SFN in accordance with one or more aspects of the present disclosure.

FIG. 5 illustrates an example of a timing diagram that supports unified TCI determination for SFN in accordance with one or more aspects of the present disclosure.

FIG. 6 illustrates an example of a process flow that supports unified TCI determination for SFN in accordance with one or more aspects of the present disclosure.

FIGS. 7 and 8 show block diagrams of devices that support unified TCI determination for SFN in accordance with one or more aspects of the present disclosure.

FIG. 9 shows a block diagram of a communications manager that supports unified TCI determination for SFN in accordance with one or more aspects of the present disclosure.

FIG. 10 shows a diagram of a system including a device that supports unified TCI determination for SFN in accordance with one or more aspects of the present disclosure.

FIGS. 11 and 12 show block diagrams of devices that support unified TCI determination for SFN in accordance with one or more aspects of the present disclosure.

FIG. 13 shows a block diagram of a communications manager that supports unified TCI determination for SFN in accordance with one or more aspects of the present disclosure.

FIG. 14 shows a diagram of a system including a device that supports unified TCI determination for SFN in accordance with one or more aspects of the present disclosure.

FIGS. 15 through 16 show flowcharts illustrating methods that support unified TCI determination for SFN in accordance with one or more aspects of the present disclosure.

### DETAILED DESCRIPTION

In some wireless communication systems, a user equipment (UE) may communicate with the network via two or more transmission reception points (TRP) s. In some cases, the UE may be configured to communicate via a single frequency network (SFN) configuration. In an SFN configuration, a UE may be configured to receive a same downlink transmission (e.g., a physical downlink control channel (PDCCH) transmission, a physical downlink shared channel (PDSCH) transmission, or an aperiodic channel state information (CSI) reference signal (CSI-RS)) or transmit a same uplink transmission (e.g., a physical uplink control channel (PUCCH) transmission or a physical uplink shared channel (PUSCH) transmission) using a same frequency and/or time resource. In a downlink SFN configuration, a UE may receive a same signal from multiple TRPs using different beams. In an uplink SFN configuration, the UE may transmit a same signal to multiple TRPs (e.g., mTRPs) using different beams for each of the multiple TRPs. Each TRP may be associated with a respective transmission configuration indication (TCI) state. Some wireless communications systems may apply unified TCI states. A unified TCI state refers to a TCI state that indicates a common beam for more than one downlink or uplink channel or reference signal. Currently, there may be no defined conditions for determining when to apply a unified TCI state for SFN operations.

Aspects of the disclosure relate to determining which unified TCI state to apply to a communication on a channel configured for SFN operations based on one or more conditions. For example, a UE may receive control signaling identifying a configuration of the UE to communicate with a first TRP and a second TRP using SFN operation for at least one channel (e.g., a PDCCH, a PDSCH, a PUCCH, or a PUSCH). The UE may receive control signaling indicating a unified TCI state that identifies a beam at the UE that is applicable to more than one channel including the at least one channel configured according to the SFN operation. The UE may determine whether to apply the indicated unified TCI state (e.g., or a default beam) to a communication (e.g., transmission of or reception of a signal) on the channel configured according to the SFN operation based on one or more conditions. For example, the one or more conditions may include whether a time threshold between the indication of the unified TCI state and the communication satisfies a threshold (e.g., in order to switch the beam to the beam indicated by the unified TCI state). Another example condition may include whether the SFN operation was configured for a PDCCH, a PDSCH, a PUCCH, or a PUSCH. Another example condition may include a number (e.g., one or two) of unified TCI states indicated to the UE. Another example condition may include a number of default beams (e.g., one or two) supported by the UE.

Aspects of the disclosure are initially described in the context of wireless communications systems. Aspects of the disclosure are further illustrated by and described with reference to apparatus diagrams, system diagrams, and flowcharts that relate to unified TCI determination for SFN.

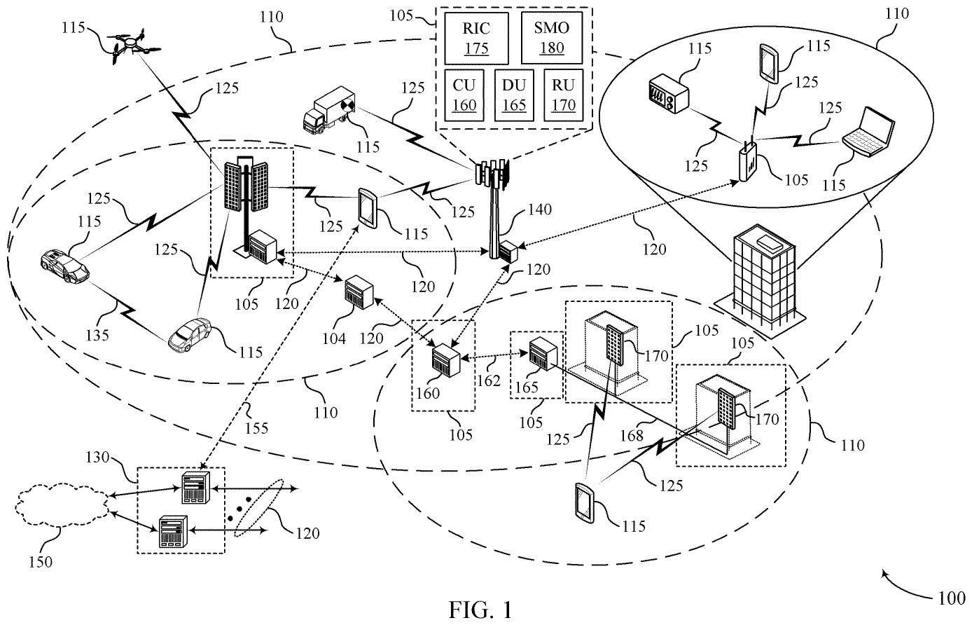

FIG. 1 illustrates an example of a wireless communications system 100 that supports unified TCI determination for SFN in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support unified TCI determination for SFN as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communication system 100, a UE 115 may communicate with the network via two or more TRPs. The wireless communications system 100 may apply a unified TCI state framework. In some cases, three types of unified TCI states may be defined. A first type of TCI state (e.g., type 1) may include a joint TCI state to indicate a common beam for at least one downlink channel or reference signal and at least one uplink channel or reference signal (e.g., including UE-specific PDCCH, UE-specific PDSCH, UE-specific PUCCH, and UE-specific PUSCH). A second type of TCI state (e.g., type 2) may include a downlink TCI state to indicate a common beam for more than one downlink channel or reference signal (e.g., including at least UE-specific PDCCH and UE-specific PDSCH). A third type of TCI state (e.g., type 3) may include an uplink TCI state to indicate a common beam for more than one uplink channel or reference signal (e.g., including at least UE-specific PUCCH and UE-specific PUSCH). For example, the network may indicate to the UE 115 multiple downlink or uplink states for multiple TRPs.

In some cases, the UE 115 may be configured to transmit uplink communications via an SFN configuration). In some cases, the UE may be configured to communicate via an SFN configuration. In an SFN configuration, a UE may be configured to receive a same downlink transmission (e.g., a PDCCH transmission, a PDSCH transmission, or an aperiodic CSI-RS) or transmit a same uplink transmission (e.g., a PUCCH transmission or a PUSCH transmission) using a same frequency and/or time resource. In a downlink SFN configuration, a UE may receive a same signal from multiple TRPs using different beams via different antenna panels at the UE 115 and using the same set of time and frequency resources. In an uplink SFN configuration, the UE 115 may transmit a same uplink signal to two or more TRPs using different beams via different antenna panels at the UE 115 and using the same set of time and frequency resources. Example applications for an uplink SFN configuration may include customer premises equipment, fixed wireless broadband, or industrial devices. In some cases, to facilitate simultaneous multi-panel uplink transmission for higher uplink throughput and reliability (e.g., focusing on FR2 and multi-TRP), uplink precoding indication for PUSCH may be specified, where no new codebook is introduced for multi-panel simultaneous transmission. In some cases, a total number of layers may be up to four across all panels and a total number of codewords may be up to two across all panels, considering single downlink control information (DCI) and multi-DCI based multi-TRP operation. In some cases, to facilitate simultaneous multi-panel uplink transmission for higher uplink throughput and reliability (e.g., focusing on FR2 and multi-TRP), uplink beam indication for PUCCH or PUSCH may be specified, where a unified TCI framework may be assumed considering single DCI and multi-DCI based multi-TRP operation. For the case of multi-DCI based multi-TRP operation, in some examples only PUSCH+PUSCH or PUCCH+PUCCH may be transmitted across two panels in a same component carrier. In some cases, timing advances for uplink multi-DCI for multi-TRP operation may be specified. In some cases, power control for uplink single DCI for multi-TRP operation may be applied.

The UE 115 may determine which unified TCI state to apply to a communication on a channel configured for SFN operations based on one or more conditions. For example, a UE may receive control signaling identifying a configuration of the UE to communicate with a first TRP and a second TRP using SFN operation for at least one channel (e.g., a PDCCH, a PDSCH, a PUCCH, or a PUSCH). The UE may receive control signaling indicating a unified TCI state that identifies a beam at the UE that is applicable to more than one channel including the at least one channel configured according to the SFN operation. The UE may determine whether to apply the indicated unified TCI state (e.g., or a default beam) to a communication (e.g., transmission of or reception of a signal) on the channel configured according to the SFN operation based on one or more conditions. For example, the one or more conditions may include whether a time threshold between the indication of the unified TCI state and the communication satisfies a threshold (e.g., in order to switch the beam to the beam indicated by the unified TCI state). Another example condition may include whether the SFN operation was configured for a PDCCH, a PDSCH, a PUCCH, or a PUSCH. Another example condition may include a number (e.g., one or two) of unified TCI states indicated to the UE. Another example condition may include a number of default beams (e.g., one or two) supported by the UE.

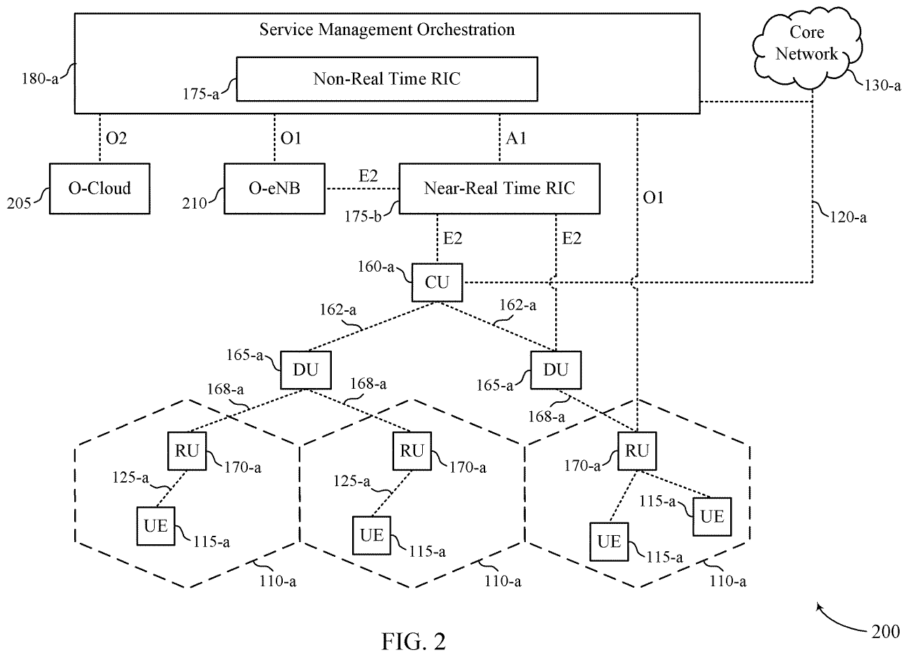

FIG. 2 illustrates an example of a network architecture 200 (e.g., a disaggregated base station architecture, a disaggregated RAN architecture) that supports unified TCI determination for SFN in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

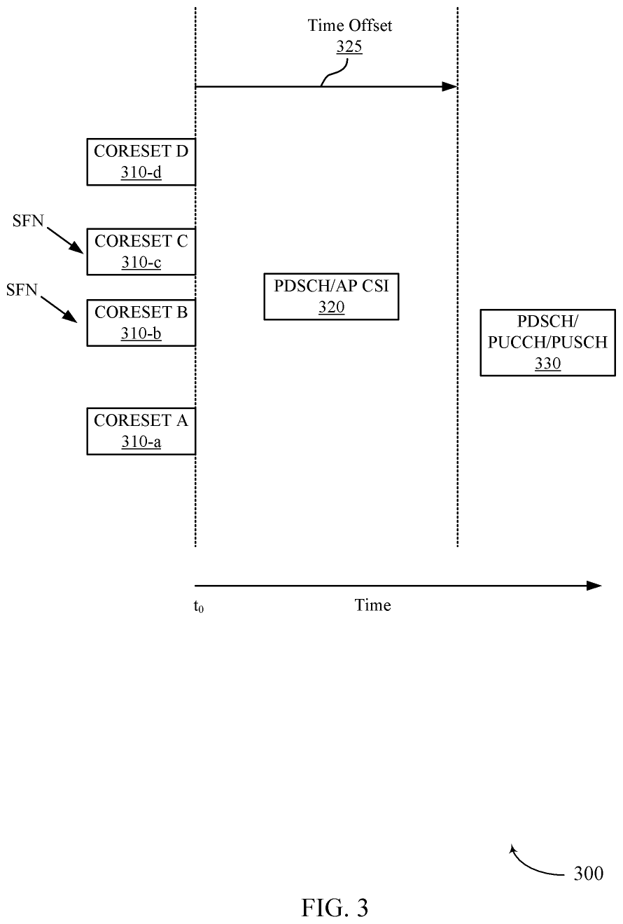

FIG. 3 illustrates an example of a timing diagram 300 that supports unified TCI determination for SFN in accordance with one or more aspects of the present disclosure. In some examples, the timing diagram 300 may be implemented by or may implement aspects of wireless communications system 100.

A UE 115 may be configured with multiple CORESETs. For example, a UE 115 may be configured with a CORESET A 310-a, a CORESET B 310-b, a CORESET C 310-c, and a CORESET D 310-d. The CORESET B 310-b and the CORESET C 310-c may be configured for SFN operation. For example, each of the CORESET B 310-b and the CORESET C 310-c may be configured with two TCI states to support SFN operation.

At time to, the UE 115 may receive a PDCCH transmission via one of the CORESETS 310 scheduling another transmission. For example, the PDCCH may schedule a PDSCH or aperiodic CSI 320 or a PDSCH, PUCCH, or PUSCH 330. A time offset 325 may be a threshold time for the UE 115 to decode the scheduling DCI in the PDCCH. The scheduling DCI may indicate a unified TCI state to apply for the PDSCH or aperiodic CSI 320 or the PDSCH, PUCCH, or PUSCH 330. A time offset 325. The PDSCH or aperiodic CSI 320 may be within the time offset 325, and the PDSCH, PUCCH, or PUSCH 330 may be outside of the time offset 325. Accordingly, the UE 115 may use a default beam to receive the PDSCH or aperiodic CSI 320. The UE 115 may use the beam indicated by the unified TCI state indicated in the scheduling DCI for the PDSCH, PUCCH, or PUSCH 330.

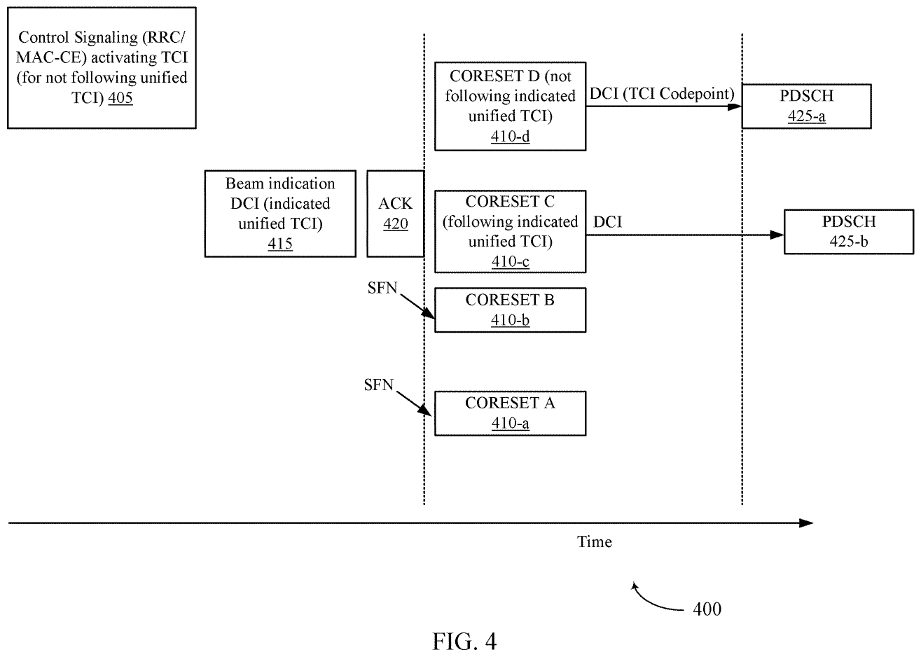

FIG. 4 illustrates an example of a timing diagram 400 that supports unified TCI determination for SFN in accordance with one or more aspects of the present disclosure. In some examples, the timing diagram 300 may be implemented by or may implement aspects of wireless communications system 100.

A UE 115 may be configured with multiple CORESET. For example, a UE 115 may be configured with a CORESET A 410-a, a CORESET B 410-b, a CORESET C 410-c, and a CORESET D 410-d. The CORESET A 410-a and the CORESET B 410-b may be configured for SFN operation. For example, each of the CORESET A 410-a and the CORESET B 410-b may be configured with two TCI states to support SFN operation.

First control signaling 405 (e.g., an RRC message or a MAC control element (MAC-CE)) may activate a default TCI state (e.g., a default beam). A beam indication DCI 415 may indicate a unified TCI state for one or more of the CORESETs 410. The UE 115 may transmit an acknowledgment (ACK) 420 for the beam indication DCI 415. Some CORESETs (e.g., the CORESET D 410-d) may not follow the unified TCI state. For example, a DCI may schedule a PDSCH 425-a in the CORESET D 410-d, and the UE 115 may apply a default beam for the PDSCH 425-a in the CORESET D 410-d (e.g., indicated in the control signaling 405). A DCI may schedule a PDSCH 425-b in the CORESET C 410-c, and the UE 115—may apply the beam associated with the unified TCI state indicated in the beam indication DCI 415 for the PDSCH 425-b.

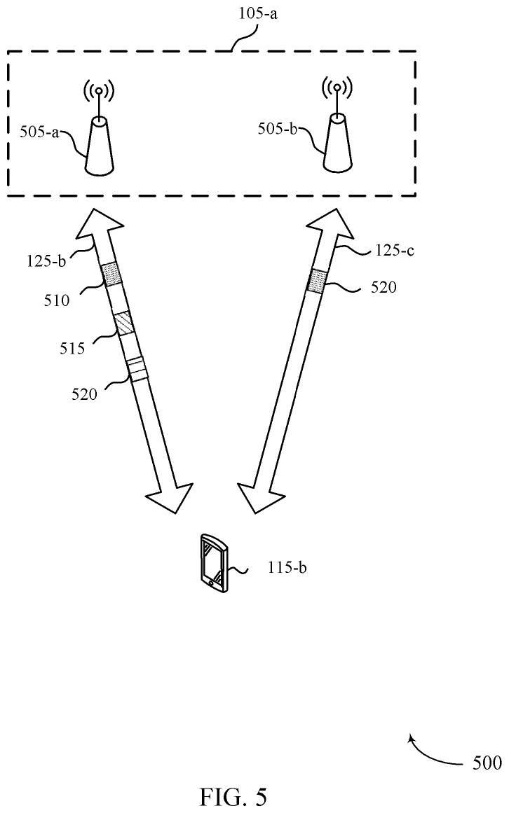

FIG. 5 illustrates an example of a wireless communications system 500 that supports unified TCI determination for SFN in accordance with one or more aspects of the present disclosure. In some examples, the wireless communications system 500 may implement aspects of wireless communications system 100. The wireless communications system 500 may include a UE 115-b, which may be an example of a UE 115 as described herein. The wireless communications system 500 may include a network entity 105-a, which may be an example of a network entity 105 as described herein.

The UE 115-b may operate in a multiple TRP mode with a first TRP 505-a and a second TRP 505-b. In some cases, the first TRP 505-a and the second TRP 505-b may be located at a same network entity 105-a. In some cases, the first TRP 505-a and the second TRP 505-b may be located at different network entities.

The UE 115-b may be capable of performing simultaneous communication with the first TRP 505-a and the second TRP 505-b (e.g., using a same set of time resources, or a same set of frequency resource, or both, but different spatial resources). The UE 115-b may communicate with the first TRP 505-a using a communication link 125-b. The UE 115-b may communicate with the second TRP 505-b using a communication link 125-c. The communication link 125-b and the communication link 125-c may include bi-directional links that enable both uplink and downlink communication. For example, the UE 115-b may transmit uplink transmissions, such as uplink control signals or uplink data signals, to the first TRP 505-a using the communication link 125-b and the first TRP 505-a may transmit downlink transmissions, such as downlink control signals or downlink data signals, to the UE 115-b using the communication link 125-b. The UE 115-b may transmit uplink transmissions, such as uplink control signals or uplink data signals, to the second TRP 505-b using the communication link 125-c and the second TRP 505-b may transmit downlink transmissions, such as downlink control signals or downlink data signals, to the UE 115-b using the communication link 125-c. In some examples, different TRPs (e.g., the first TRP 505-a and the second TRP 505-b) may have different TRP identifiers (IDs). In some examples, different TRPs may be identified through an association with other IDs, such as a CORESET pool index, closed loop index, TCI ID, TCI group ID, or a sounding reference signal resource set ID.

In a single DCI multi-TRP operation or a multi-DCI multi-TRP operation, the UE 115-b may communicate with the first TRP 505-a and the second TRP 505-b using space division multiplexing, frequency division multiplexing, or time division multiplexing, or a combination thereof. The wireless communication system may support DCI repetition (e.g., across CORESETs associated with the first TRP 505-a and the second TRP 505-b), PUSCH and PUCCH repetition, a downlink SFN configuration, or an uplink SFN configuration. For example, in downlink, the UE 115-b may receive PDSCH or PDCCH messages according to an SFN configuration. For example, the UE 115-b may receive a same downlink signal (e.g., a PDSCH or PDCCH message) from the first TRP 505-a and the second TRP 505-b on different beams using different antenna panels at the UE 115-b. In uplink, the UE 115-b may transmit PUSCH or PUCCH messages according to an SFN configuration. For example, the UE 115-b may transmit a same uplink signal to the first TRP 505-a and the second TRP 505-b on different beams using different antenna panels at the UE 115-b.

The UE 115-b may receive first control signaling 510 identifying a configuration of the UE 115-b to communicate with the first TRP 505-a and the second TRP 505-b using SFN communications for at least one channel. The UE 115-b may receive second control signaling 515 indicating that the UE 115-b is to use a unified TCI state that identifies that a single beam at the UE 115-b is applicable to a set of multiple channels (e.g., PDCCH, PDSCH, PUCCH, or PUSCH), including the at least one channel. The UE may communicate a communication 520 on the at least one channel according to at least one beam based on determining, according to one or more conditions, whether to apply the unified TCI state to the at least one channel.

Accordingly, for multi-TRP communications, the UE 115-b may determine one or more conditions, for example, whether SFN is configured for a PDCCH, whether SFN is configured for a PDSCH, whether SFN is inter-cell or intra-cell configured, whether a single TCI or multiple TCIs are configured for a CORESET, whether the UE supports a single or two default beams, or whether an RRC parameter ‘enableTwoDefaultTCI’ is configured.

Table 1 shows example scenarios if the scheduling offset (e.g., the time offset between DCI and scheduled PDSCH or CSI-RS as described with reference to FIG. 3), is less than a threshold, where the UE 115-b may determine one or more default beams for receiving the scheduled PDSCH or CSI-RS. Table 2 shows example scenarios if the scheduling offset (e.g., as described with reference to FIG. 3), is greater than or equal to the threshold, where the UE 115-b may determine one or more beams for received the scheduled PDSCH, PUSCH, and/or PUCCH. When SFN is configured by a RRC parameter for a PDCCH/CORESET, and two unified TCI states are indicated, the associated PDCCH/CORESET operates in an SFN operation, otherwise the PDCCH/CORESET does not operate in an SFN operation (e.g., when SFN is configured for a PDCCH/CORESET and only one unified TCI is indicated for the PDCCH/CORESET, the associated PDCCH/CORESET does not operate according to an SFN operation).

TABLE 1

| | SFN configured | Non-SFN configured |
|---|---|---|
| | for PDSCH | for PDSCH |
| SFN configured | Scenario 1 | Scenario 2 |
| for PDCCH | | |
| Non-SFN | Scenario 3 | N/A |
| configured | | |
| for PDCCH | | |

TABLE 2

| | SFN configured | Non-SFN configured |
|---|---|---|
| | for | for |
| | PDSCH/PUSCH/PUCCH | PDSCH/PUSCH/PUCCH |
| SFN configured | Scenario 4 | Scenario 5 |
| for PDCCH | | |
| Non-SFN | Scenario 6 | N/A |
| configured | | |
| for PDCCH | | |

In Scenario 1, a first example case (e.g., case 1) may involve intra-cell beam management (e.g., all used TCI states have the same serving synchronization signal block (SSB) as a root quasi co-location (QCL) resource signal).

A first example subcase (e.g., case 1.1) for the first example case of scenario 1 may involve a single unified TCI state being indicated, where the unified TCI state may be indicated by a TCI indication DCI and/or a TCI activation MAC-CE. In case 1.1, if the UE 115-b supports a single default beam (e.g., case 1.1.1), in a first example (option 1), the UE 115-b may use the indicated unified TCI state as the default beam for a PDSCH or aperiodic CSI-RS. In case 1.1.1, in a second example (option 2), the UE 115-b may use one TCI state of one CORESET. For example, the UE 115-b may use the first TCI state of one CORESET (e.g., the CORESET with the lowest CORESET identifier (ID)) (e.g., option 2.0). In another example, the UE 115-b may use one of the TCI states of one of the SFN CORESETS (e.g., among the SFN CORESETS not following the indicated unified TCI state) (e.g., option 2.1). In another example case, the UE may use the TCI state of one non-SFN CORESET (e.g., option 2.2). In case 1.1.1, in a third example (option 3), the UE 115-b may use the first TCI state of the lowest CORESET ID monitored in the latest slot as the default beam.

In case 1.1, if two default beams are supported by the UE 115-b (e.g., case 1.1.2), in a first example (e.g., option 1), the UE 115-b may use one TCI codepoint with two TCI states (e.g., the lowest TCI codepoint). In case 1.1.2, in a second example (e.g., option 2), the UE 115-b may use two TCI states of one of the SFN CORESETs (e.g., among those SFN CORESETs not following the indicated unified TCI state). In case 1.1.2, in a third example (e.g., option 3), the default beams may depend on the RRC parameter ‘enableTwoDefaultTCI’. For example, if enableTwoDefaultTCI is configured, the UE 115-b may either use one TCI codepoint with two TCI states (case 1.1.2 option 1) or may use two TCI states of one of the SFN CORESETs (case 1.1.2 option 2). If enableTwoDefaultTCI is not configured, the UE 115-b may use the options in case 1.1.1.

A second example subcase (e.g., case 1.2) for the first example case of scenario 1 may involve two unified TCI states being indicated, where the two unified TCI states may be indicated by TCI indication DCI and/or TCI activation MAC-CE. In case 1.2, if the UE 115-b supports a single default beam (e.g., case 1.2.1), in a first example (e.g., option 1), the UE 115-b may use one indicated TCI state as the default beam for a PDSCH or aperiodic CSI-RS. In case 1.2.1, in a second example (e.g., option 2), the UE 115-b may use one TCI state of one CORESET (e.g., as in case 1.1.1 option 2).

In the case 1.2, if the UE 115-b supports two default beams (e.g., case 1.2.2), a first example (e.g., option 1), the UE 115-b may use the two indicated TCI states. In the case 1.2.2, in a some examples (options 1-3), the UE 115-b may use the same options as in options 1-3 of case 1.2.1.

In Scenario 1, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 1 may involve a single unified TCI state being indicated. In case 2.1, if the UE 115-b supports a single default beam (e.g., case 2.1.1), in a first example (option 1), the UE 115-b may use the same option as option 3 of case 1.1.1. In case 2.1.1, in a second example (e.g., option 2), the UE 115-b may use one TCI of one CORESET (e.g., the same as option 2 of case 1.1.1).

In case 2.1, if two default beams are supported by the UE 115-b (e.g., case 2.1.2), in a first example (e.g., option 1), the UE 115-b may use one TCI codepoint with 2 TCI states and at least one TCI state has the serving-cell SSB as the root QCL resource signal (e.g., lowest TCI codepoint). In case 2.1.2, in a second example (e.g., option 2), the UE 115-b may use the two TCI states of one of the SFN CORESETs (e.g., among those SFN CORESETs not following the indicated unified TCI state and with at least one TCI state having the serving-cell SSB as the root QCL resource signal). In case 2.1.2, in a third example (e.g., option 3), the default beams may depend on the RRC parameter ‘enableTwoDefaultTCI’. For example, if enableTwoDefaultTCI is configured, the UE 115-b may either use option 1 or option 2 of case 2.1.2. If enableTwoDefaultTCI is not configured, the UE 115-b may use the options in case 2.1.1.

A second example subcase (e.g., case 2.2) for the second example case of scenario 1 may involve two unified TCI states being indicated. In case 2.2, if the UE 115-b supports a single default beam (e.g., case 2.2.1), in a first example (e.g., option 1), the UE 115-b may use one indicated TCI state associated with the serving-cell SSB as the default beam for PDSCH or aperiodic CSI-RS. For example, the UE 115-b may select the first TCI state among TCI states associated with the serving-cell SSB. In case 2.2.1, in a second example (e.g., option 2), the UE 115-b may use one TCI associated with the serving-cell SSB of one CORESET. For example, the UE 115-b may use the first TCI state associated with the serving-cell SSB of one CORESET (e.g., the CORESET with the lowest CORESET identifier (ID)) (e.g., option 2.0). In another example, the UE 115-b may use one TCI state associated with the serving-cell SSB of one of the SFN CORESETS (e.g., among the CORESETS not following the indicated unified TCI state) (e.g., option 2.1). In another example case, the UE may use the TCI state associated with the serving-cell SSB on one non-SFN CORESET (e.g., option 2.2).

In case 2.1, if two default beams are supported by the UE 115-b (e.g., case 2.2.2), in one example (option 0), the UE 115-b may use two indicated TCI states if at least one indicated TCI state is associated with the serving-cell SSB. In case 2.2.2, in another example (e.g., option 1), the UE 115-b may use one TCI codepoint with two TCI states where at least one of the TCI states is associated with the serving-cell SSB (e.g., the lowest TCI codepoint). In case 2.2.2, in another example (e.g., option 2), the UE 115-b may use two TCI states of one of the SFN CORESETs where at least one of the TCI states is associated with the serving-cell SSB (e.g., among those CORESETs not following the indicated unified TCI state). In case 2.2.2, in another example (e.g., option 3), the default beams may depend on the RRC parameter ‘enableTwoDefaultTCI’. For example, if enableTwoDefaultTCI is configured, the UE 115-b may either option 0, option 1, or option 2 of case 2.2.2. If enableTwoDefaultTCI is not configured, the UE 115-b may use the options in case 2.2.1.

In Scenario 2, a first example case (e.g., case 1) may involve intra-cell beam management (e.g., all used TCI states have the same serving-cell SSB as a root QCL resource signal).

A first example subcase (e.g., case 1.1) for the first example case of scenario 2 may involve a single unified TCI state being indicated. In case 1.1, if the UE 115-b supports a single default beam (e.g., case 1.1.1), in a first example (option 1), the UE 115-b may use the indicated unified TCI state as the default beam for a PDSCH or aperiodic CSI-RS. In case 1.1.1, in a second example (option 2), the UE 115-b may use one TCI state of one CORESET. For example, the UE 115-b may use the first TCI state of one CORESET (e.g., the CORESET with the lowest CORESET identifier (ID)) (e.g., option 2.0). In another example, the UE 115-b may use one of the TCI states of one of the SFN CORESETS (e.g., among the CORESETS not following the indicated unified TCI state) (e.g., option 2.1). In another example case, the UE may use the TCI state on one non-SFN CORESET (e.g., option 2.2). In case 1.1.1, in a third example (option 3), the UE 115-b may use the first TCI state of the lowest CORESET ID monitored in the latest slot as the default beam.

A second example subcase (e.g., case 1.2) for the first example case of scenario 2 may involve two unified TCI states being indicated. In case 1.2, if the UE 115-b supports a single default beam (e.g., case 1.2.1), in a first example (e.g., option 1), the UE 115-b may use one indicated TCI state as the default beam for a PDSCH or aperiodic CSI-RS. In case 1.2.1, in a second example (e.g., option 2), the UE 115-b may use one TCI state of one CORESET (e.g., as in case 1.1.1 option 2).

In Scenario 2, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 2 may involve a single unified TCI state being indicated. In case 2.1, if the UE 115-b supports a single default beam (e.g., case 2.1.1), in a first example (option 1), the UE 115-b may use the same option as option 3 of case 1.1.1. In case 2.1.1, in a second example (e.g., option 2), the UE 115-b may use one TCI of one CORESET (e.g., the same as option 2 of case 1.1.1).

A second example subcase (e.g., case 2.2) for the second example case of scenario 2 may involve two unified TCI states being indicated. In case 2.2, if the UE 115-b supports a single default beam (e.g., case 2.2.1), in a first example (e.g., option 1), the UE 115-b may use one indicated TCI state associated with the serving-cell SSB as the default beam for PDSCH or aperiodic CSI-RS. For example, the UE 115-b may select the first TCI state among TCI states associated with the serving-cell SSB. In case 2.2.1, in a second example (e.g., option 2), the UE 115-b may use one TCI associated with the serving-cell SSB of one CORESET. For example, the UE 115-b may use the first TCI state associated with the serving-cell SSB of one CORESET (e.g., the CORESET with the lowest CORESET identifier (ID)) (e.g., option 2.0). In another example, the UE 115-b may use one TCI state associated with the serving-cell SSB of one of the SFN CORESETS (e.g., among the CORESETS not following the indicated unified TCI state) (e.g., option 2.1). In another example case, the UE may use the TCI state associated with the serving-cell SSB on one non-SFN CORESET (e.g., option 2.2).

In Scenario 3, a first example case (e.g., case 1) may involve intra-cell beam management (e.g., all used TCI states have the same serving-cell SSB as a root quasi co-location QCL resource signal).

A first example subcase (e.g., case 1.1) for the first example case of scenario 3 may involve a single unified TCI state being indicated. In case 1.1, if the UE 115-b supports a single default beam (e.g., case 1.1.1), in a first example (option 1), the UE 115-b may use the indicated unified TCI state as the default beam for a PDSCH or aperiodic CSI-RS. In case 1.1.1, in a second example (option 2), the UE 115-b may use one TCI state of one CORESET. For example, the UE 115-b may use the first TCI state of one CORESET (e.g., the CORESET with the lowest CORESET identifier (ID)) (e.g., option 2.0). In case 1.1.1, in a third example (option 3), the UE 115-b may use the first TCI state of the lowest CORESET ID in the latest slot as the default beam.

In case 1.1, if two default beams are supported by the UE 115-b (e.g., case 1.1.2), in a first example (e.g., option 1), the UE 115-b may use one TCI codepoint with two TCI states (e.g., the lowest TCI codepoint). In case 1.1.2, in another example (e.g., option 3), the default beams may depend on the RRC parameter ‘enableTwoDefaultTCI’. For example, if enableTwoDefaultTCI is configured, the UE 115-b may use one TCI codepoint with two TCI states (case 1.1.2 option 1). If enableTwoDefaultTCI is not configured, the UE 115-b may use the options in case 1.1.1.

A second example subcase (e.g., case 1.2) for the first example case of scenario 3 may involve two unified TCI states being indicated. In case 1.2, if the UE 115-b supports a single default beam (e.g., case 1.2.1), in a first example (e.g., option 1), the UE 115-b may use one indicated TCI state as the default beam for a PDSCH or aperiodic CSI-RS. In case 1.2.1, in a second example (e.g., option 2), the UE 115-b may use one TCI state of one CORESET (e.g., as in case 1.1.1 option 2).

In the case 1.2, if the UE 115-b supports two default beams (e.g., case 1.2.2), a first example (e.g., option 1), the UE 115-b may use the two indicated TCI states. In the case 1.2.2, in a some examples (options 1-3), the UE 115-b may use the same options as in options 1-3 of case 1.2.1.

In Scenario 3, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 3 may involve a single unified TCI state being indicated. In case 2.1, if the UE 115-b supports a single default beam (e.g., case 2.1.1), in a first example (option 1), the UE 115-b may use the same option as option 3 of case 1.1.1. In case 2.1.1, in a second example (e.g., option 2), the UE 115-b may use one TCI of one CORESET (e.g., the same as option 2 of case 1.1.1).

In case 2.1, if two default beams are supported by the UE 115-b (e.g., case 2.1.2), in a first example (e.g., option 1), the UE 115-b may use one TCI codepoint with 2 TCI states and at least one TCI state has the serving-cell SSB as the root QCL resource signal (e.g., lowest TCI codepoint). In case 2.1.2, in another example (e.g., option 3), the default beams may depend on the RRC parameter ‘enableTwoDefaultTCI’. For example, if enableTwoDefaultTCI is configured, the UE 115-b may either use option 1 of case 2.1.2. If enableTwoDefaultTCI is not configured, the UE 115-b may use the options in case 2.1.1.

A second example subcase (e.g., case 2.2) for the second example case of scenario 3 may involve two unified TCI states being indicated. In case 2.2, if the UE 115-b supports a single default beam (e.g., case 2.2.1), in a first example (e.g., option 1), the UE 115-b may use one indicated TCI state associated with the serving-cell SSB as the default beam for PDSCH or aperiodic CSI-RS. For example, the UE 115-b may select the first TCI state among TCI states associated with the serving-cell SSB. In case 2.2.1, in a second example (e.g., option 2), the UE 115-b may use one TCI associated with the serving-cell SSB of one CORESET. For example, the UE 115-b may use the first TCI state associated with the serving-cell SSB of one CORESET (e.g., the CORESET with the lowest CORESET identifier (ID)) (e.g., option 2.0). In another example case, the UE 115-b may use the TCI state associated with the serving-cell SSB on one non-SFN CORESET (e.g., option 2.2). In case 2.2.1, in a third example (e.g., option 3), the UE 115-b may use a default beam (e.g., the first TCI state of the lowest CORESET ID in the latest slot).

In case 2.1, if two default beams are supported by the UE 115-b (e.g., case 2.2.2), in one example (option 0), the UE 115-b may use two indicated TCI states if at least one indicated TCI state is associated with the serving-cell SSB. In case 2.2.2, in another example (e.g., option 1), the UE 115-b may use one TCI codepoint with two TCI states where at least one of the TCI states is associated with the serving-cell SSB (e.g., the lowest TCI codepoint). In case 2.2.2, in another example (e.g., option 3), the default beams may depend on the RRC parameter ‘enableTwoDefaultTCI’. For example, if enableTwoDefaultTCI is configured, the UE 115-b may either option 0 or option 1of case 2.2.2. If enableTwoDefaultTCI is not configured, the UE 115-b may use the options in case 2.2.1.

In Scenario 4, a first example case (e.g., case 1) may involve intra-cell beam management (e.g., all used TCI states have the same serving-cell SSB as a root QCL resource signal).

A first example subcase (e.g., case 1.1) for the first example case of scenario 4 may involve a single unified TCI state being indicated by either DCI or in a single TCI codepoint activated by MAC-CE. In case 1.1, if the UE 115-b supports a single beam (e.g., case 1.1.1), in a first example (option 1), the UE 115-b may use the indicated unified TCI state. In case 1.1.1, in a third example (option 3), the UE 115-b may use the TCI state of the scheduling CORESET, if not following the indicated TCI state.

In case 1.1, if two beams are supported by the UE 115-b (e.g., case 1.1.2), in an example (e.g., option 2), the UE 115-b may use two TCI states of one of the scheduling CORESETs, if not following the indicated TCI state and having two TCI states.

A second example subcase (e.g., case 1.2) for the first example case of scenario 4 may involve two unified TCI states being indicated by either DCI or in a single TCI codepoint activated by MAC-CE. In case 1.2, if the UE 115-b supports a single beam (e.g., case 1.2.1), in a first example (e.g., option 0), the UE 115-b may use the single indicated TCI state from the scheduling DCI. In case 1.2.1, in another example (e.g., option 3), the UE 115-b may use the first TCI state of the scheduling CORESET, if not following the indicated TCI state.

In the case 1.2, if the UE 115-b supports two beams (e.g., case 1.2.2), in one example (e.g., option 0), the UE 115-b may use the two indicated unified TCI states. In the case 1.2.2, in another example (e.g., option OA), the UE 115-b may use the two indicated TCI states from the scheduling DCI. In the case 1.2.2, in another example (e.g., option 1), the UE 115-b may use the two TCI states of the scheduling CORESETs, if not following the indicated TCI and having two TCI states.

In Scenario 4, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 4 may involve a single unified TCI state being indicated (e.g., by either DCI or in a single TCI codepoint activated by MAC-CE). In case 2.1, if the UE 115-b supports a single beam (e.g., case 2.1.1), in an example (e.g., option 0), the UE may the single indicated beam from the scheduling DCI. In case 2.1.1, in another example (option 1), the UE 115-b may use the same option as option 3 of case 1.1.1.

In case 2.1, if two beams are supported by the UE 115-b (e.g., case 2.1.2), in in an example (e.g., option 0), the UE 115-b may use the two indicated TCIs from the CORESET of the scheduling DCI. In case 2.1.2, in a second example (e.g., option 2), the UE 115-b may use the two TCI states of the scheduling CORESET, if not following the indicated TCI state and having two TCI states.

A second example subcase (e.g., case 2.2) for the second example case of scenario 4 may involve two unified TCI states being indicated (e.g., by either DCI or in a single TCI codepoint activated by MAC-CE). In case 2.2, if the UE 115-b supports a single beam (e.g., case 2.2.1), in one example (e.g., option 0), the UE 115-b may use the single indicated TCI state from the scheduling DCI. In case 2.2.1, in another example (e.g., option 3), the UE 115-b may use the first TCI state of the scheduling CORESET, if not following the indicated TCI state.

In case 2.1, if two beams are supported by the UE 115-b (e.g., case 2.2.2), in one example (option 0), the UE 115-b may use two indicated TCI states. In case 2.2.2, in another example (e.g., option 0A), the UE 115-b may use two indicated TCI states from the scheduling DCI. In case 2.2.2, in another example (e.g., option 2), the UE 115-b may use the two TCI states of the scheduling CORESET, if not following the indicated TCI state and having only two TCI states.

In Scenario 5, a first example case (e.g., case 1) may involve intra-cell beam management (e.g., all used TCI states have the same serving-cell SSB as a root QCL resource signal).

A first example subcase (e.g., case 1.1) for the first example case of scenario 5 may involve a single unified TCI state being indicated by either DCI or in a single TCI codepoint activated by MAC-CE. In case 1.1, if the UE 115-b supports a single beam (e.g., case 1.1.1), in a first example (option 1), the UE 115-b may use the indicated unified TCI state. In case 1.1.1, in another example (e.g., option 0A), the UE 115-b may use the single indicated TCI state from the scheduling DCI. In case 1.1.1, in a third example (option 3), the UE 115-b may use the TCI state of the scheduling CORESET, if not following the indicated TCI state.

A second example subcase (e.g., case 1.2) for the first example case of scenario 5 may involve two unified TCI states being indicated by either DCI or in a single TCI codepoint activated by MAC-CE. In case 1.2, if the UE 115-b supports a single beam (e.g., case 1.2.1), in a first example, the UE 115-b may use the one indicated TCI state (e.g., the first TCI state). In case 1.2.1, in another example (e.g., option 0A), the UE 115-b may use the single indicated TCI state from the scheduling DCI. In case 1.2.1, in another example (e.g., option 3), the UE 115-b may use the first TCI state of the scheduling CORESET, if not following the indicated TCI state.

In the case 1.2, if the UE 115-b supports two beams (e.g., case 1.2.2), in one example (e.g., option 0), the UE 115-b may use the two indicated unified TCI states. In the case 1.2.2, in another example (e.g., option 0A), the UE 115-b may use the two indicated TCI states from the scheduling DCI. In the case 1.2.2, in another example (e.g., option 1), the UE 115-b may use the two TCI states of the scheduling CORESETs, if not following the indicated TCI and having two TCI states.

In Scenario 5, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 5 may involve a single unified TCI state being indicated (e.g., by either DCI or in a single TCI codepoint activated by MAC-CE). In case 2.1, if the UE 115-b supports a single beam (e.g., case 2.1.1), in an example (e.g., option 0), the UE may the single indicated beam from the scheduling DCI. In case 2.1.1, in another example (option 1), the UE 115-b may use the same option as option 3 of case 1.1.1.

A second example subcase (e.g., case 2.2) for the second example case of scenario 5 may involve two unified TCI states being indicated (e.g., by either DCI or in a single TCI codepoint activated by MAC-CE). In case 2.2, if the UE 115-b supports a single beam (e.g., case 2.2.1), in one example, the UE 115-b may use the one indicated TCI state. In case 2.2.1, in another example (e.g., option 0A), the UE 115-b may use the single indicated TCI state from the scheduling DCI. In case 2.2.1, in another example (e.g., option 3), the UE 115-b may use the first TCI state of the scheduling CORESET, if not following the indicated TCI state.

In Scenario 6, a first example case (e.g., case 1) may involve intra-cell beam management (e.g., all used TCI states have the same serving-cell SSB as a root QCL resource signal).

A first example subcase (e.g., case 1.1) for the first example case of scenario 6 may involve a single unified TCI state being indicated by either DCI or in a single TCI codepoint activated by MAC-CE. In case 1.1, if the UE 115-b supports a single beam (e.g., case 1.1.1), in a first example (option 1), the UE 115-b may use the indicated unified TCI state. In the case 1.1.1, in another example (e.g., option 0A), the UE 115-b may use the single indicated TCI state from the scheduling DCI. In the case 1.1.1, in a third example (option 3), the UE 115-b may use the TCI state of the scheduling CORESET, if not following the indicated TCI state.

In case 1.1, if two beams are supported by the UE 115-b (e.g., case 1.1.2), in a first example (e.g., option 1), the UE 115-b may use the one TCI codepoint with 2 TCI states (e.g., the lowest codepoint). In case 1.1.2, in an example (e.g., option 0A), the UE 115-b may use the two indicated TCI states from the scheduling DCI. In case 1.1.2, in another example (e.g., option 3), the beams may depend on the RRC parameter ‘enableTwoDefaultTCI’. For example, if enableTwoDefaultTCI is configured, the UE 115-b may use one TCI codepoint with two TCI states (case 1.1.2 option 1). If enableTwoDefaultTCI is not configured, the UE 115-b may use the options in case 1.1.1.

A second example subcase (e.g., case 1.2) for the first example case of scenario 6 may involve two unified TCI states being indicated by either DCI or in a single TCI codepoint activated by MAC-CE. In case 1.2, if the UE 115-b supports a single beam (e.g., case 1.2.1), in a first example (e.g., option 1), the UE 115-b may use one indicated unified TCI state (e.g., the first TCI state). In case 1.2.1, in another example (e.g., option 0A), the UE 115-b may use the single indicated TCI state from the scheduling DCI. In case 1.2.1, in a second example (e.g., option 2), the UE 115-b use the same option as option 3 from case 1.1.1.

In the case 1.2, if the UE 115-b supports two beams (e.g., case 1.2.2), in one example (e.g., option 0), the UE 115-b may use the two indicated unified TCI states. In the case 1.2.2, in another example (e.g., option A), the UE 115-b may use the two indicated TCI states from the scheduling DCI. In the case 1.2.2, in other examples, the UE may use the same options 1, 2, or 3 from case 1.1.2.

In Scenario 6, a second example case (e.g., case 2) may involve single DCI inter-cell multi TRP (e.g., at least one used TCI has a non-serving-cell SSB as a root QCL resource signal).

A first example subcase (e.g., case 2.1) for the second example case of scenario 6 may involve a single unified TCI state being indicated (e.g., by either DCI or in a single TCI codepoint activated by MAC-CE). In case 2.1, if the UE 115-b supports a single beam (e.g., case 2.1.1), in an example (e.g., option 0A), the UE 115-b may use the indicated TCI state from the scheduling DCI. In case 2.1.1, in another example (e.g., option 1), the UE may use option 3 from case 1.1.1.

In case 2.1, if two beams are supported by the UE 115-b (e.g., case 2.1.2), in in an example (e.g., option 0A), the UE 115-b may use the two indicated TCIs from the scheduling DCI. In case 2.1.2, in a second example (e.g., option 1), the UE 115-b may use one TCI codepoint with 2 TCI states where at least one TCI state has the serving-cell SSB as a root QCL resource signal (e.g., the lowest codepoint).

A second example subcase (e.g., case 2.2) for the second example case of scenario 6 may involve two unified TCI states being indicated (e.g., by either DCI or in a single TCI codepoint activated by MAC-CE). In case 2.2, if the UE 115-b supports a single beam (e.g., case 2.2.1), in one example (e.g., option 0A), the UE 115-b may use the indicated TCI state from the scheduling DCI. In case 2.2.1, in another example (e.g., option 1), the UE 115-b may use option 3 from case 1.1.1. In case 2.2.1, in another example (e.g., option 3), the UE 115-b may use the TCI state of the scheduling CORESET, if not following the indicated TCI state.

In case 2.1, if two beams are supported by the UE 115-b (e.g., case 2.2.2), in one example (option 0A), the UE 115-b may use the two indicated TCI states from the scheduling DCI. In case 2.2.2, in another example (e.g., option 1), the UE 115-b may use one TCI codepoint with two TCIs where at least one TCI has the serving-cell SSB as a root QCL resource signal (e.g., the lowest codepoint).

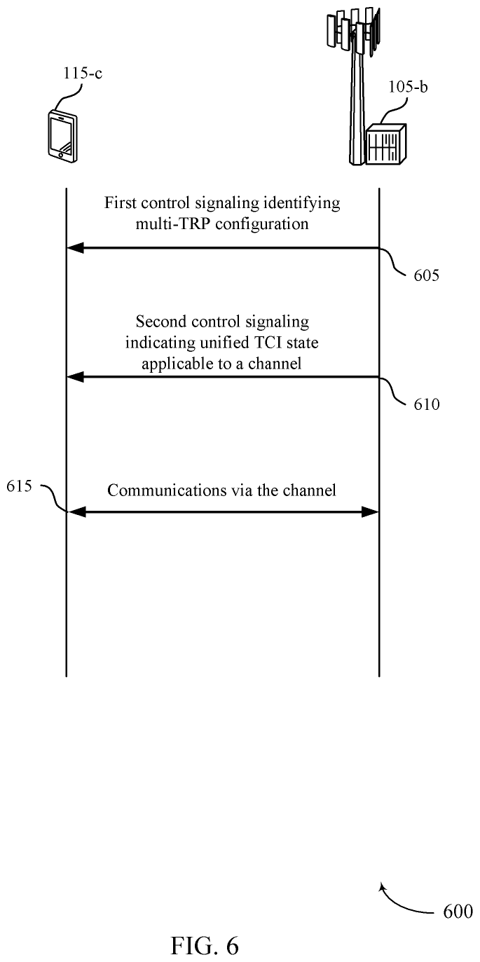

FIG. 6 illustrates an example of a process flow 600 that supports unified TCI determination for SFN in accordance with one or more aspects of the present disclosure. The process flow 600 may include a UE 115-c, which may be an example of a UE 115 as described herein. The process flow 600 may include a network entity 105-b, which may be an example of a network entity 105 as described herein. In the following description of the process flow 600, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 600, and other operations may be added to the process flow 600.

At 605, the UE 115-c may receive, from the network entity 105-b, first control signaling identifying a configuration of the UE 115-c to communicate with a first TRP and a second TRP using SFN communications for at least one channel.

At 610, the UE 115-c may receive, from the network entity 105-b, second control signaling indicating that the UE 115-c is to use a unified TCI state that identifies that a single beam at the UE 115-c is applicable to a set of multiple channels, including the at least one channel.

At 615, the UE 115-c and the network entity 105-b may communicate on the at least one channel according to at least one beam based on determining, according to one or more conditions, whether to apply the unified TCI state to the at least one channel.

In some examples, the one or more conditions include a time threshold, and communicating on the at least one channel includes communicating on the at least one channel according to the unified TCI state based on a time for communication on the at least one channel satisfying the time threshold.

In some examples, the one or more conditions include a time threshold, and communicating on the at least one channel includes communicating on the at least one channel according to a default beam based on a time for communication on the at least one channel satisfying the time threshold.

In some examples, the one or more conditions include whether SFN operation is configured at the UE 115-c for a downlink control channel. The UE 115-c may determine whether to apply the unified TCI state to the at least one channel based on the SFN operation being configured for the downlink control channel.

In some examples, the one or more conditions include whether SFN operation is configured at the UE 115-c for at least one of a downlink shared channel, an uplink control channel, or an uplink shared channel. The UE 115-c may determine whether to apply the unified TCI state to the at least one channel based on the SFN operation being configured for the at least one of the downlink shared channel, the uplink control channel, or the uplink shared channel.

In some examples, the one or more conditions include one of intra-cell beam management or inter-cell beam management being configured at the UE 115-c. The UE 115-c may determine whether to apply the unified TCI state to the at least one channel based on the one of the intra-cell beam management or the inter-cell beam management that is configured at the UE 115-c.

In some examples, the one or more conditions include one of a single unified TCI state or two unified TCI states having been indicated to the UE 115-c. The UE 115-c may receive a control message indicating the one of the single unified TCI state or the two unified TCI states. The UE 115-c may determine whether to apply the unified TCI state to the at least one channel based on the one of the single unified TCI state or the two unified TCI states being indicated to the UE 115-c.

In some examples, the one or more conditions include whether a single default beam is supported by the UE 115-c or a set of multiple default beams are supported by the UE 115-c. The UE 115-c may determine whether to apply the unified TCI state to the at least one channel based on the single default beam being supported by the UE 115-c or the set of multiple default beams being supported by the UE 115-c.

In some examples, the UE 115-c may receive third control signaling indicating to enable the UE 115-c to use a set of multiple default beams. The UE 115-c may determine to apply the set of multiple default beams for the at least one channel based on the UE 115-c having received the third control signaling enabling the UE 115-c to use the set of multiple default beams.

In some examples, the second control signaling includes a DCI message.

In some examples, the at least one channel includes at a PDCCH, a PDSCH, a PUCCH, a PUSCH, or any combination thereof.

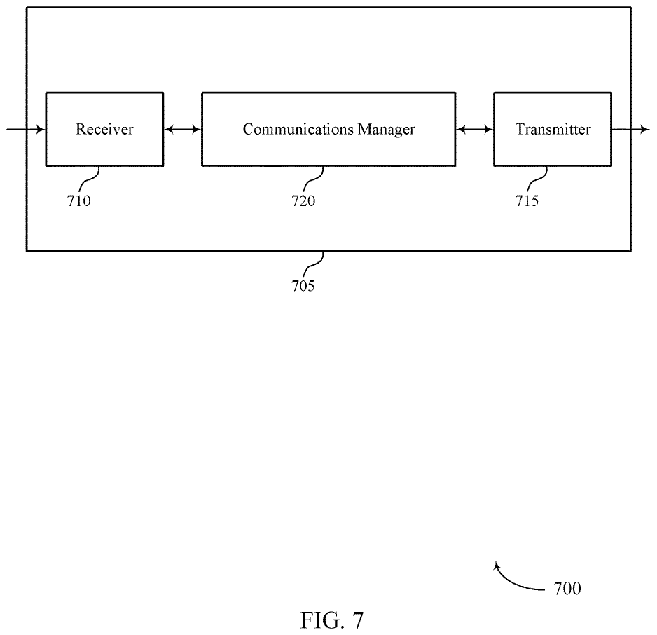

FIG. 7 shows a block diagram 700 of a device 705 that supports unified TCI determination for SFN in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to unified TCI determination for SFN). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to unified TCI determination for SFN). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of unified TCI determination for SFN as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving first control signaling identifying a configuration of the UE to communicate with a first TRP and a second TRP using SFN communications for at least one channel. The communications manager 720 may be configured as or otherwise support a means for receiving second control signaling indicating that the UE is to use a unified TCI state that identifies that a single beam at the UE is applicable to a set of multiple channels, including the at least one channel. The communications manager 720 may be configured as or otherwise support a means for communicating on the at least one channel according to at least one beam based on determining, according to one or more conditions, whether to apply the unified TCI state to the at least one channel.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

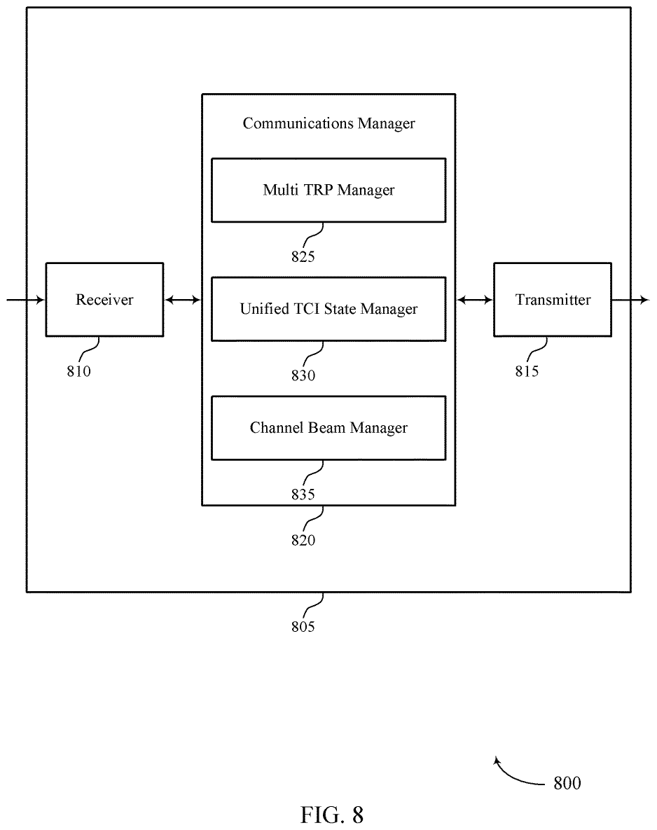

FIG. 8 shows a block diagram 800 of a device 805 that supports unified TCI determination for SFN in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to unified TCI determination for SFN). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to unified TCI determination for SFN). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of unified TCI determination for SFN as described herein. For example, the communications manager 820 may include a multi TRP manager 825, a unified TCI state manager 830, a channel beam manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The multi TRP manager 825 may be configured as or otherwise support a means for receiving first control signaling identifying a configuration of the UE to communicate with a first TRP and a second TRP using SFN communications for at least one channel. The unified TCI state manager 830 may be configured as or otherwise support a means for receiving second control signaling indicating that the UE is to use a unified TCI state that identifies that a single beam at the UE is applicable to a set of multiple channels, including the at least one channel. The channel beam manager 835 may be configured as or otherwise support a means for communicating on the at least one channel according to at least one beam based on determining, according to one or more conditions, whether to apply the unified TCI state to the at least one channel.

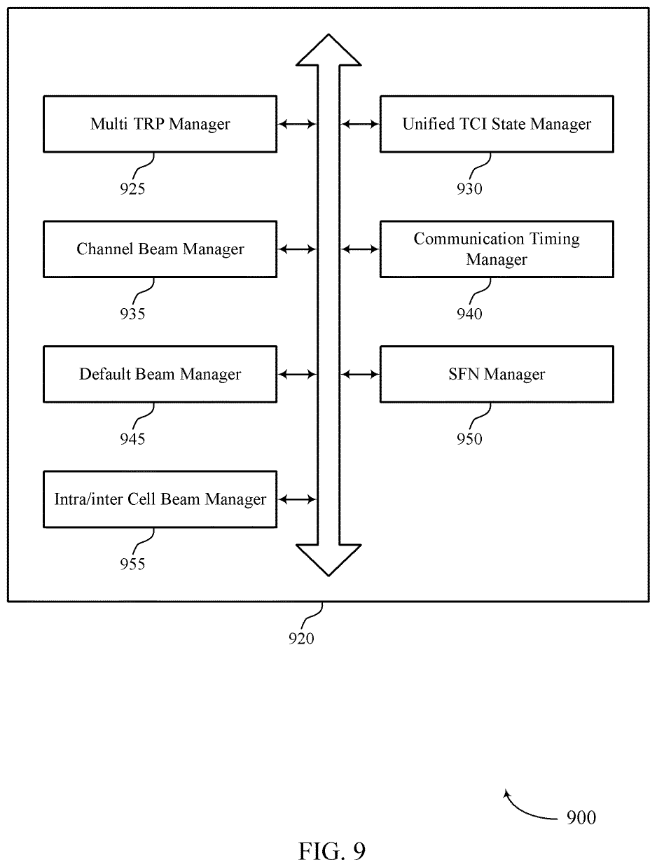

FIG. 9 shows a block diagram 900 of a communications manager 920 that supports unified TCI determination for SFN in accordance with one or more aspects of the present disclosure. The communications manager 920 may be an example of aspects of a communications manager 720, a communications manager 820, or both, as described herein. The communications manager 920, or various components thereof, may be an example of means for performing various aspects of unified TCI determination for SFN as described herein. For example, the communications manager 920 may include a multi TRP manager 925, a unified TCI state manager 930, a channel beam manager 935, a communication timing manager 940, a default beam manager 945, an SFN manager 950, an intra/inter cell beam manager 955, or any combination thereof. Each of these components may communicate, directly or indirectly, with one another (e.g., via one or more buses).

The communications manager 920 may support wireless communication at a UE in accordance with examples as disclosed herein. The multi TRP manager 925 may be configured as or otherwise support a means for receiving first control signaling identifying a configuration of the UE to communicate with a first TRP and a second TRP using SFN communications for at least one channel. The unified TCI state manager 930 may be configured as or otherwise support a means for receiving second control signaling indicating that the UE is to use a unified TCI state that identifies that a single beam at the UE is applicable to a set of multiple channels, including the at least one channel. The channel beam manager 935 may be configured as or otherwise support a means for communicating on the at least one channel according to at least one beam based on determining, according to one or more conditions, whether to apply the unified TCI state to the at least one channel.

In some examples, the one or more conditions include a time threshold and, to support communicating on the at least one channel, the communication timing manager 940 may be configured as or otherwise support a means for communicating on the at least one channel according to the unified TCI state based on a time for communication on the at least one channel satisfying the time threshold.

In some examples, the one or more conditions include a time threshold and, to support communicating on the at least one channel, the default beam manager 945 may be configured as or otherwise support a means for communicating on the at least one channel according to a default beam based on a time for communication on the at least one channel satisfying the time threshold.

In some examples, the one or more conditions include whether SFN operation is configured at the UE for a downlink control channel, and the SFN manager 950 may be configured as or otherwise support a means for determining whether to apply the unified TCI state to the at least one channel based on the SFN operation being configured for the downlink control channel.

In some examples, the one or more conditions include whether SFN operation is configured at the UE for at least one of a downlink shared channel, an uplink control channel, or an uplink shared channel, and the SFN manager 950 may be configured as or otherwise support a means for determining whether to apply the unified TCI state to the at least one channel based on the SFN operation being configured for the at least one of the downlink shared channel, the uplink control channel, or the uplink shared channel.

In some examples, the one or more conditions include one of intra-cell beam management or inter-cell beam management being configured at the UE, and the intra/inter cell beam manager 955 may be configured as or otherwise support a means for determining whether to apply the unified TCI state to the at least one channel based on the one of the intra-cell beam management or the inter-cell beam management that is configured at the UE.

In some examples, the one or more conditions include one of a single unified TCI state or two unified TCI states having been indicated to the UE, and the unified TCI state manager 930 may be configured as or otherwise support a means for: receiving a control message indicating the one of the single unified TCI state or the two unified TCI states; and determining whether to apply the unified TCI state to the at least one channel based on the one of the single unified TCI state or the two unified TCI states being indicated to the UE.

In some examples, the one or more conditions include whether a single default beam is supported by the UE or a plurality of default beams are supported by the UE, and the default beam manager 945 may be configured as or otherwise support a means for determining whether to apply the unified TCI state to the at least one channel based on the single default beam being supported by the UE or the plurality of default beams being supported by the UE.

In some examples, the default beam manager 945 may be configured as or otherwise support a means for receiving third control signaling indicating to enable the UE to use a set of multiple default beams. In some examples, the default beam manager 945 may be configured as or otherwise support a means for determining to apply the set of multiple default beams for the at least one channel based on the UE having received the third control signaling enabling the UE to use the set of multiple default beams.

In some examples, the second control signaling includes a DCI message.

In some examples, the at least one channel includes at a physical downlink control channel, a physical downlink shared channel, a physical uplink control channel, a physical uplink shared channel, or any combination thereof.

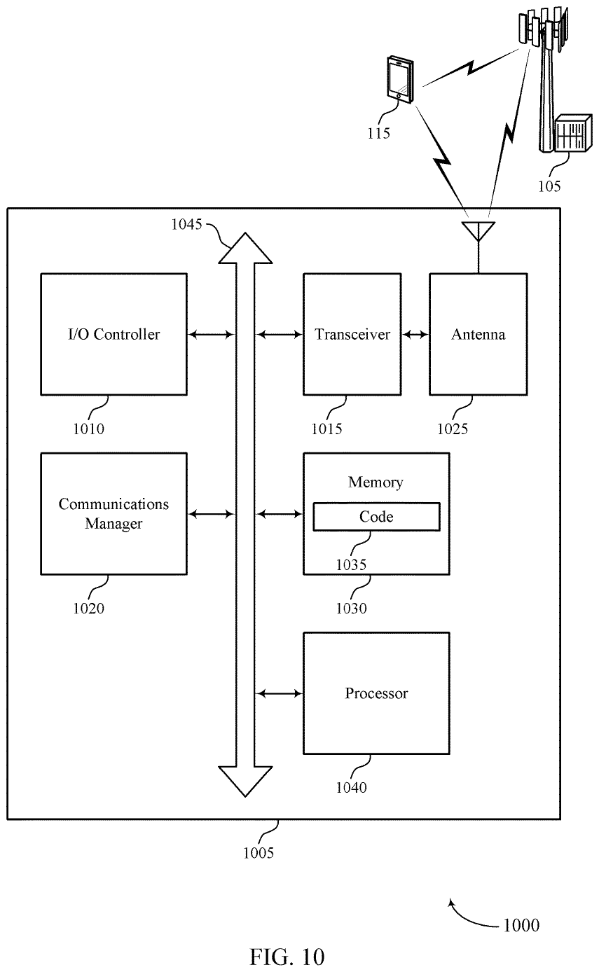

FIG. 10 shows a diagram of a system 1000 including a device 1005 that supports unified TCI determination for SFN in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting unified TCI determination for SFN). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving first control signaling identifying a configuration of the UE to communicate with a first TRP and a second TRP using SFN communications for at least one channel. The communications manager 1020 may be configured as or otherwise support a means for receiving second control signaling indicating that the UE is to use a unified TCI state that identifies that a single beam at the UE is applicable to a set of multiple channels, including the at least one channel. The communications manager 1020 may be configured as or otherwise support a means for communicating on the at least one channel according to at least one beam based on determining, according to one or more conditions, whether to apply the unified TCI state to the at least one channel.

By including or configuring the communications manager 1020 in accordance with examples as described herein, the device 1005 may support techniques for more efficient utilization of communication resources and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of unified TCI determination for SFN as described herein, or the processor 1040 and the memory 1030 may be otherwise configured to perform or support such operations.

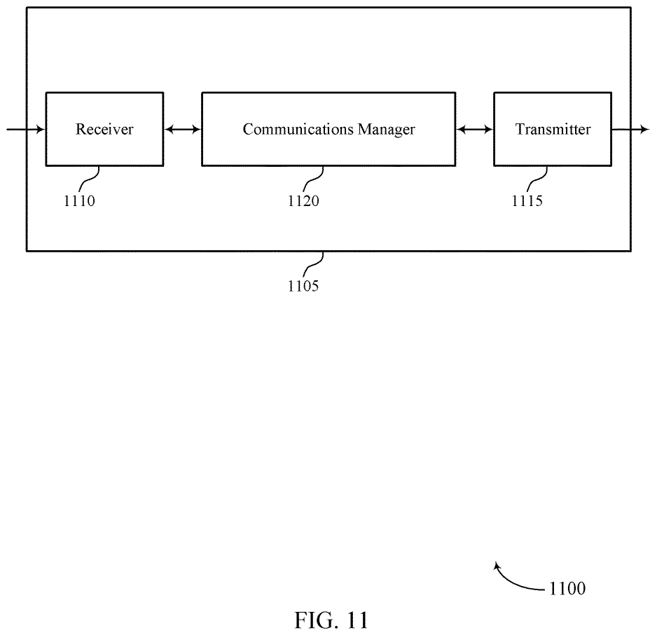

FIG. 11 shows a block diagram 1100 of a device 1105 that supports unified TCI determination for SFN in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of unified TCI determination for SFN as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for outputting first control signaling identifying a configuration for a UE to use to communicate, using SFN communications for at least one channel, with a first TRP and a second TRP associated with the network entity. The communications manager 1120 may be configured as or otherwise support a means for outputting second control signaling indicating that the UE is to use a unified TCI state that identifies that a single beam at the UE is applicable to a set of multiple channels, including the at least one channel. The communications manager 1120 may be configured as or otherwise support a means for communicating on the at least one channel according to at least one beam based on determining, according to one or more conditions, whether the UE is to apply the unified TCI state to the at least one channel.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

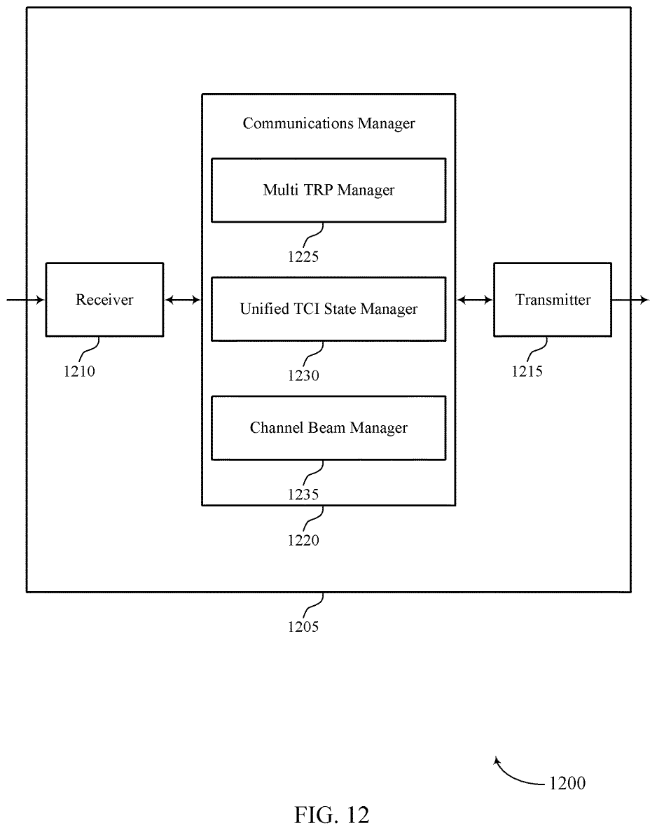

FIG. 12 shows a block diagram 1200 of a device 1205 that supports unified TCI determination for SFN in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of unified TCI determination for SFN as described herein. For example, the communications manager 1220 may include a multi TRP manager 1225, a unified TCI state manager 1230, a channel beam manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The multi TRP manager 1225 may be configured as or otherwise support a means for outputting first control signaling identifying a configuration for a UE to use to communicate, using SFN communications for at least one channel, with a first TRP and a second TRP associated with the network entity. The unified TCI state manager 1230 may be configured as or otherwise support a means for outputting second control signaling indicating that the UE is to use a unified TCI state that identifies that a single beam at the UE is applicable to a set of multiple channels, including the at least one channel. The channel beam manager 1235 may be configured as or otherwise support a means for communicating on the at least one channel according to at least one beam based on determining, according to one or more conditions, whether the UE is to apply the unified TCI state to the at least one channel.

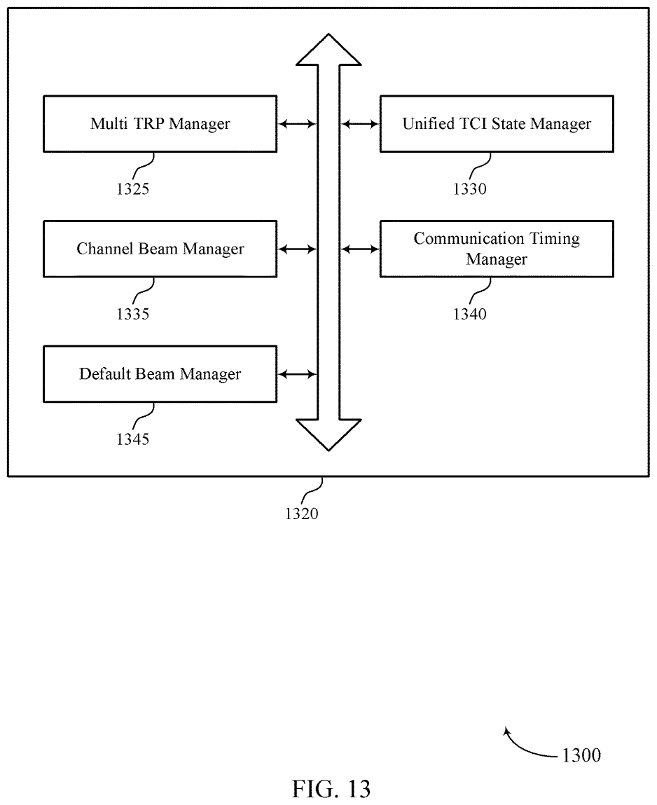

FIG. 13 shows a block diagram 1300 of a communications manager 1320 that supports unified TCI determination for SFN in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of unified TCI determination for SFN as described herein. For example, the communications manager 1320 may include a multi TRP manager 1325, a unified TCI state manager 1330, a channel beam manager 1335, a communication timing manager 1340, a default beam manager 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The multi TRP manager 1325 may be configured as or otherwise support a means for outputting first control signaling identifying a configuration for a UE to use to communicate, using SFN communications for at least one channel, with a first TRP and a second TRP associated with the network entity. The unified TCI state manager 1330 may be configured as or otherwise support a means for outputting second control signaling indicating that the UE is to use a unified TCI state that identifies that a single beam at the UE is applicable to a set of multiple channels, including the at least one channel. The channel beam manager 1335 may be configured as or otherwise support a means for communicating on the at least one channel according to at least one beam based on determining, according to one or more conditions, whether the UE is to apply the unified TCI state to the at least one channel.

In some examples, the one or more conditions include a time threshold and, to support communicating on the at least one channel, the communication timing manager 1340 may be configured as or otherwise support a means for communicating on the at least one channel according to the unified TCI state based on a time for communication on the at least one channel satisfying the time threshold.

In some examples, the one or more conditions include a time threshold and, to support communicating on the at least one channel, the communication timing manager 1340 may be configured as or otherwise support a means for communicating on the at least one channel according to a default beam based on a time for communication on the at least one channel satisfying the time threshold.

In some examples, the one or more conditions include whether SFN operation is configured at the UE for a downlink control channel.

In some examples, the one or more conditions include whether SFN operation is configured at the UE for at least one of a downlink shared channel.

In some examples, the one or more conditions include one of intra-cell beam management or inter-cell beam management being configured at the UE.

In some examples, the one or more conditions includes one of a single unified transmission configuration indication state or two unified transmission configuration indication states having been indicated to the UE, and unified TCI state manager 1330 may be configured as or otherwise support a means for outputting a control message indicating the one of the single unified TCI state or the two unified TCI states.

In some examples, the one or more conditions include whether a single default beam is supported by the UE or a set of multiple default beams are supported by the UE.

In some examples, the default beam manager 1345 may be configured as or otherwise support a means for outputting third control signaling to enable the UE to use a set of multiple default beams, where the UE determines to apply the set of multiple default beams for the at least one channel based on the UE having received the third control signaling enabling the UE to use the set of multiple default beams.

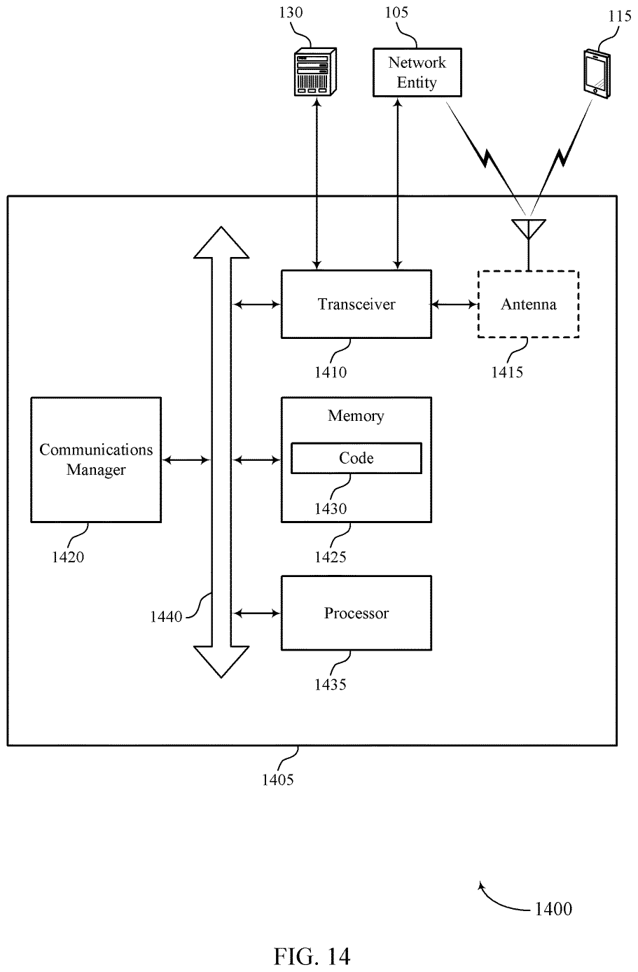

FIG. 14 shows a diagram of a system 1400 including a device 1405 that supports unified TCI determination for SFN in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting unified TCI determination for SFN). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for outputting first control signaling identifying a configuration for a UE to use to communicate, using SFN communications for at least one channel, with a first TRP and a second TRP associated with the network entity. The communications manager 1420 may be configured as or otherwise support a means for outputting second control signaling indicating that the UE is to use a unified TCI state that identifies that a single beam at the UE is applicable to a set of multiple channels, including the at least one channel. The communications manager 1420 may be configured as or otherwise support a means for communicating on the at least one channel according to at least one beam based on determining, according to one or more conditions, whether the UE is to apply the unified TCI state to the at least one channel.

By including or configuring the communications manager 1420 in accordance with examples as described herein, the device 1405 may support techniques for more efficient utilization of communication resources and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. For example, the communications manager 1420 may be configured to receive or transmit messages or other signaling as described herein via the transceiver 1410. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of unified TCI determination for SFN as described herein, or the processor 1435 and the memory 1425 may be otherwise configured to perform or support such operations.

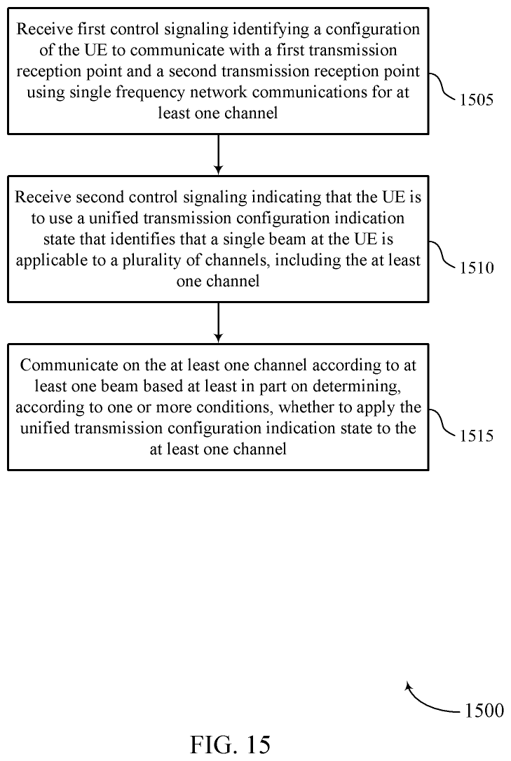

FIG. 15 shows a flowchart illustrating a method 1500 that supports unified TCI determination for SFN in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling identifying a configuration of the UE to communicate with a first TRP and a second TRP using SFN communications for at least one channel. The operations of 1505 may be performed in accordance with examples as disclosed herein. In some examples, aspects of the operations of 1505 may be performed by a multi TRP manager 925 as described with reference to FIG. 9. Additionally, or alternatively, means for performing 1505 may, but not necessarily, include, for example, antenna 1025, transceiver 1015, communications manager 1020, memory 1030 (including code 1035), processor 1040 and/or bus 1045

At 1510, the method may include receiving second control signaling indicating that the UE is to use a unified TCI state that identifies that a single beam at the UE is applicable to a set of multiple channels, including the at least one channel. The operations of 1510 may be performed in accordance with examples as disclosed herein. In some examples, aspects of the operations of 1510 may be performed by a unified TCI state manager 930 as described with reference to FIG. 9. Additionally, or alternatively, means for performing 1510 may, but not necessarily, include, for example, antenna 1025, transceiver 1015, communications manager 1020, memory 1030 (including code 1035), processor 1040 and/or bus 1045

At 1515, the method may include communicating on the at least one channel according to at least one beam based on determining, according to one or more conditions, whether to apply the unified TCI state to the at least one channel. The operations of 1515 may be performed in accordance with examples as disclosed herein. In some examples, aspects of the operations of 1515 may be performed by a channel beam manager 935 as described with reference to FIG. 9. Additionally, or alternatively, means for performing 1515 may, but not necessarily, include, for example, antenna 1025, transceiver 1015, communications manager 1020, memory 1030 (including code 1035), processor 1040 and/or bus 1045

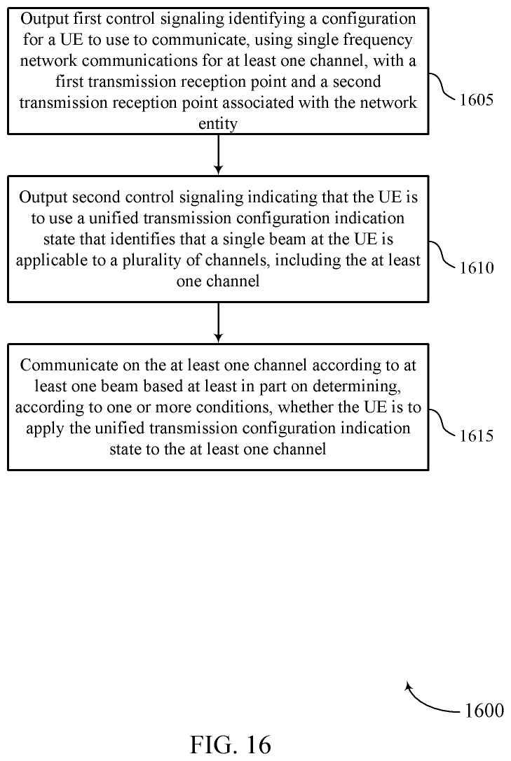

FIG. 16 shows a flowchart illustrating a method 1600 that supports unified TCI determination for SFN in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting first control signaling identifying a configuration for a UE to use to communicate, using SFN communications for at least one channel, with a first TRP and a second TRP associated with the network entity. The operations of 1605 may be performed in accordance with examples as disclosed herein. In some examples, aspects of the operations of 1605 may be performed by a multi TRP manager 1325 as described with reference to FIG. 13. Additionally, or alternatively, means for performing 1605 may, but not necessarily, include, for example, antenna 1415, transceiver 1410, communications manager 1420, memory 1425 (including code 1430), processor 1435 and/or bus 1440.

At 1610, the method may include outputting second control signaling indicating that the UE is to use a unified TCI state that identifies that a single beam at the UE is applicable to a set of multiple channels, including the at least one channel. The operations of 1610 may be performed in accordance with examples as disclosed herein. In some examples, aspects of the operations of 1610 may be performed by a unified TCI state manager 1330 as described with reference to FIG. 13.

At 1615, the method may include communicating on the at least one channel according to at least one beam based on determining, according to one or more conditions, whether the UE is to apply the unified TCI state to the at least one channel. The operations of 1615 may be performed in accordance with examples as disclosed herein. In some examples, aspects of the operations of 1615 may be performed by a channel beam manager 1335 as described with reference to FIG. 13.

The following provides an overview of aspects of the present disclosure:

Aspect 1: A method for wireless communication at a UE, comprising: receiving first control signaling identifying a configuration of the UE to communicate with a first TRP and a second TRP using SFN communications for at least one channel; receiving second control signaling indicating that the UE is to use a unified TCI state that identifies that a single beam at the UE is applicable to a plurality of channels, including the at least one channel; and communicating on the at least one channel according to at least one beam based at least in part on determining, according to one or more conditions, whether to apply the unified TCI state to the at least one channel.

Aspect 2: The method of aspect 1, wherein the one or more conditions comprise a time threshold, and communicating on the at least one channel comprises: communicating on the at least one channel according to the unified TCI state based at least in part on a time for communication on the at least one channel satisfying the time threshold.

Aspect 3: The method of any of aspects 1 through 2, wherein the one or more conditions comprise a time threshold, and communicating on the at least one channel comprises: communicating on the at least one channel according to a default beam based at least in part on a time for communication on the at least one channel satisfying the time threshold.

Aspect 4: The method of any of aspects 1 through 3, wherein the one or more conditions comprise whether SFN operation is configured at the UE for a downlink control channel, the method comprising determining whether to apply the unified TCI state to the at least one channel based at least in part on the SFN operation being configured for the downlink control channel.

Aspect 5: The method of any of aspects 1 through 4, wherein the one or more conditions comprise whether SFN operation is configured at the UE for at least one of a downlink shared channel, an uplink control channel, or an uplink shared channel, the method comprising determining whether to apply the unified TCI state to the at least one channel based at least in part on the SFN operation being configured for the at least one of the downlink shared channel, the uplink control channel, or the uplink shared channel.

Aspect 6: The method of any of aspects 1 through 5, wherein the one or more conditions comprise one of intra-cell beam management or inter-cell beam management being configured at the UE, the method comprising determining whether to apply the unified TCI state to the at least one channel based at least in part on the one of the intra-cell beam management or the inter-cell beam management that is configured at the UE.

Aspect 7: The method of any of aspects 1 through 6, wherein the one or more conditions comprise one of a single unified TCI state or two unified TCI states having been indicated to the UE, the method comprising receiving a control message indicating the one of the single unified TCI state or the two unified TCI states; and determining whether to apply the unified TCI state to the at least one channel based at least in part on the one of the single unified TCI state or the two unified TCI states being indicated to the UE.

Aspect 8: The method of any of aspects 1 through 7, wherein the one or more conditions comprise whether a single default beam is supported by the UE or a plurality of default beams are supported by the UE, the method comprising determining whether to apply the unified TCI state to the at least one channel based at least in part on the single default beam being supported by the UE or the plurality of default beams being supported by the UE.

Aspect 9: The method of any of aspects 1 through 8, further comprising: receiving third control signaling indicating to enable the UE to use a plurality of default beams; and determining to apply the plurality of default beams for the at least one channel based at least in part on the UE having received the third control signaling enabling the UE to use the plurality of default beams.

Aspect 10: The method of any of aspects 1 through 9, wherein the second control signaling comprises a DCI message.

Aspect 11: The method of any of aspects 1 through 10, wherein the at least one channel comprises at a physical downlink control channel, a physical downlink shared channel, a physical uplink control channel, a physical uplink shared channel, or any combination thereof.

Aspect 12: A method for wireless communication at a network entity, comprising: outputting first control signaling identifying a configuration for a UE to use to communicate, using SFN communications for at least one channel, with a first TRP and a second TRP associated with the network entity; outputting second control signaling indicating that the UE is to use a unified TCI state that identifies that a single beam at the UE is applicable to a plurality of channels, including the at least one channel; and communicating on the at least one channel according to at least one beam based at least in part on determining, according to one or more conditions, whether the UE is to apply the unified TCI state to the at least one channel.

Aspect 13: The method of aspect 12, wherein the one or more conditions comprise a time threshold, and communicating on the at least one channel comprises: communicating on the at least one channel according to the unified TCI state based at least in part on a time for communication on the at least one channel satisfying the time threshold.

Aspect 14: The method of any of aspects 12 through 13, wherein the one or more conditions comprise a time threshold, and communicating on the at least one channel comprises: communicating on the at least one channel according to a default beam based at least in part on a time for communication on the at least one channel satisfying the time threshold.

Aspect 15: The method of any of aspects 12 through 14, wherein the one or more conditions comprise whether SFN operation is configured at the UE for a downlink control channel.

Aspect 16: The method of any of aspects 12 through 15, wherein the one or more conditions comprise whether SFN operation is configured at the UE for at least one of a downlink shared channel.

Aspect 17: The method of any of aspects 12 through 16, wherein the one or more conditions comprise one of intra-cell beam management or inter-cell beam management being configured at the UE.

Aspect 18: The method of any of aspects 12 through 17, wherein the one or more conditions comprise one of a single unified TCI state or two unified TCI states having been indicated to the UE, the method comprising outputting a control message indicating the one of the single unified TCI state or the two unified TCI states.

Aspect 19: The method of any of aspects 12 through 18, wherein the one or more conditions comprise whether a single default beam is supported by the UE or a plurality of default beams are supported by the UE.

Aspect 20: The method of any of aspects 12 through 19, further comprising: outputting third control signaling to enable the UE to use a plurality of default beams, wherein the UE determines to apply the plurality of default beams for the at least one channel based at least in part on the UE having received the third control signaling enabling the UE to use the plurality of default beams.

Aspect 21: An apparatus comprising a memory, transceiver, and at least one processor coupled with the memory and the transceiver, the at least one processor configured to perform a method of any of aspects 1 through 11.

Aspect 22: An apparatus for wireless communication at a UE, comprising at least one means for performing a method of any of aspects 1 through 11.

Aspect 23: A non-transitory computer-readable medium storing code for wireless communication at a UE, the code comprising instructions executable by a processor to perform a method of any of aspects 1 through 11.

Aspect 24: An apparatus comprising a memory and at least one processor coupled with the memory, the at least one processor configured to perform a method of any of aspects 12 through 20.

Aspect 25: An apparatus for wireless communication at a network entity, comprising at least one means for performing a method of any of aspects 12 through 20.

Aspect 26: A non-transitory computer-readable medium storing code for wireless communication at a network entity, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first control signaling identifying a configuration of the UE to communicate with a first transmission reception point and a second transmission reception point using single frequency network communications for at least one channel;
receiving second control signaling indicating that the UE is to use a unified transmission configuration indication state that identifies that a single beam at the UE is applicable to a plurality of channels, including the at least one channel; and
communicating on the at least one channel according to at least one beam based at least in part on determining, according to one or more conditions, whether to apply the unified transmission configuration indication state to the at least one channel.

2. The method of claim 1, wherein the one or more conditions comprise a time threshold, and communicating on the at least one channel comprises:
communicating on the at least one channel according to the unified transmission configuration indication state based at least in part on a time for communication on the at least one channel satisfying the time threshold.

3. The method of claim 1, wherein the one or more conditions comprise a time threshold, and communicating on the at least one channel comprises:
communicating on the at least one channel according to a default beam based at least in part on a time for communication on the at least one channel satisfying the time threshold.

4. The method of claim 1, wherein the one or more conditions comprise whether single frequency network operation is configured at the UE for a downlink control channel, the method comprising determining whether to apply the unified transmission configuration indication state to the at least one channel based at least in part on the single frequency network operation being configured for the downlink control channel.

5. The method of claim 1, wherein the one or more conditions comprise whether single frequency network operation is configured at the UE for at least one of a downlink shared channel, an uplink control channel, or an uplink shared channel, the method comprising determining whether to apply the unified transmission configuration indication state to the at least one channel based at least in part on the single frequency network operation being configured for the at least one of the downlink shared channel, the uplink control channel, or the uplink shared channel.

6. The method of claim 1, wherein the one or more conditions comprise one of intra-cell beam management or inter-cell beam management being configured at the UE, the method comprising determining whether to apply the unified transmission configuration indication state to the at least one channel based at least in part on the one of the intra-cell beam management or the inter-cell beam management that is configured at the UE.

7. The method of claim 1, wherein the one or more conditions comprise one of a single unified transmission configuration indication state or two unified transmission configuration indication states having been indicated to the UE, the method comprising:
receiving a control message indicating the one of the single unified transmission configuration indication state or the two unified transmission configuration indication states; and
determining whether to apply the unified transmission configuration indication state to the at least one channel based at least in part on the one of the single unified transmission configuration indication state or the two unified transmission configuration indication states being indicated to the UE.

8. The method of claim 1, wherein the one or more conditions comprise whether a single default beam is supported by the UE or a plurality of default beams are supported by the UE, the method comprising determining whether to apply the unified transmission configuration indication state to the at least one channel based at least in part on the single default beam being supported by the UE or the plurality of default beams being supported by the UE.

9. The method of claim 1, further comprising:
receiving third control signaling indicating to enable the UE to use a plurality of default beams; and
determining to apply the plurality of default beams for the at least one channel based at least in part on the UE having received the third control signaling enabling the UE to use the plurality of default beams.

10. The method of claim 1, wherein the second control signaling comprises a downlink control information message.

11. The method of claim 1, wherein the at least one channel comprises at a physical downlink control channel, a physical downlink shared channel, a physical uplink control channel, a physical uplink shared channel, or any combination thereof.

12. A method for wireless communication at a network entity, comprising:
outputting first control signaling identifying a configuration for a user equipment (UE) to use to communicate, using single frequency network communications for at least one channel, with a first transmission reception point and a second transmission reception point associated with the network entity;
outputting second control signaling indicating that the UE is to use a unified transmission configuration indication state that identifies that a single beam at the UE is applicable to a plurality of channels, including the at least one channel; and
communicating on the at least one channel according to at least one beam based at least in part on determining, according to one or more conditions, whether the UE is to apply the unified transmission configuration indication state to the at least one channel.

13. The method of claim 12, wherein the one or more conditions comprise a time threshold, and communicating on the at least one channel comprises:
communicating on the at least one channel according to the unified transmission configuration indication state based at least in part on a time for communication on the at least one channel satisfying the time threshold.

14. The method of claim 12, wherein the one or more conditions comprise a time threshold, and communicating on the at least one channel comprises:
communicating on the at least one channel according to a default beam based at least in part on a time for communication on the at least one channel satisfying the time threshold.

15. The method of claim 12, wherein the one or more conditions comprise whether single frequency network operation is configured at the UE for a downlink control channel.

16. The method of claim 12, wherein the one or more conditions comprise whether single frequency network operation is configured at the UE for at least one of a downlink shared channel.

17. The method of claim 12, wherein the one or more conditions comprise one of intra-cell beam management or inter-cell beam management being configured at the UE.

18. The method of claim 12, wherein the one or more conditions comprise one of a single unified transmission configuration indication state or two unified transmission configuration indication states having been indicated to the UE, the method comprising outputting a control message indicating the one of the single unified transmission configuration indication state or the two unified transmission configuration indication states.

19. The method of claim 12, wherein the one or more conditions comprise whether a single default beam is supported by the UE or a plurality of default beams are supported by the UE.

20. The method of claim 12, further comprising:
outputting third control signaling to enable the UE to use a plurality of default beams, wherein the UE determines to apply the plurality of default beams for the at least one channel based at least in part on the UE having received the third control signaling enabling the UE to use the plurality of default beams.

21. An apparatus for wireless communication comprising:
memory;
a transceiver; and
at least one processor of a user equipment (UE), the at least one processor coupled with the memory and the transceiver, and the at least one processor configured to:
receive, via the transceiver, first control signaling identifying a configuration of the UE to communicate with a first transmission reception point and a second transmission reception point using single frequency network communications for at least one channel;
receive via the transceiver, second control signaling indicating that the UE is to use a unified transmission configuration indication state that identifies that a single beam at the UE is applicable to a plurality of channels, including the at least one channel; and
communicate via the transceiver, on the at least one channel according to at least one beam based at least in part on determining, according to one or more conditions, whether to apply the unified transmission configuration indication state to the at least one channel.

22. The apparatus of claim 21, wherein the one or more conditions comprise a time threshold, and wherein to communicate on the at least one channel the at least one processor is further configured to:
communicate on the at least one channel according to the unified transmission configuration indication state based at least in part on a time for communication on the at least one channel satisfying the time threshold.

23. The apparatus of claim 21, wherein the one or more conditions comprise a time threshold, and wherein to communicate on the at least one channel the at least one processor is further configured to:
communicate on the at least one channel according to a default beam based at least in part on a time for communication on the at least one channel satisfying the time threshold.

24. The apparatus of claim 21, wherein the one or more conditions comprise whether single frequency network operation is configured at the UE for a downlink control channel, wherein the at least one processor is further configured to:
determine whether to apply the unified transmission configuration indication state to the at least one channel based at least in part on the single frequency network operation being configured for the downlink control channel.

25. The apparatus of claim 21, wherein the one or more conditions comprise whether single frequency network operation is configured at the UE for at least one of a downlink shared channel, an uplink control channel, or an uplink shared channel, wherein the at least one processor is further configured to:
determine whether to apply the unified transmission configuration indication state to the at least one channel based at least in part on the single frequency network operation being configured for the at least one of the downlink shared channel, the uplink control channel, or the uplink shared channel.

26. The apparatus of claim 21, wherein the one or more conditions comprise one of intra-cell beam management or inter-cell beam management being configured at the UE, wherein the at least one processor is further configured to:
determine whether to apply the unified transmission configuration indication state to the at least one channel based at least in part on the one of the intra-cell beam management or the inter-cell beam management that is configured at the UE.

27. The apparatus of claim 21, wherein the one or more conditions comprise one of a single unified transmission configuration indication state or two unified transmission configuration indication states having been indicated to the UE, wherein the at least one processor is further configured to:
receive a control message indicating the one of the single unified transmission configuration indication state or the two unified transmission configuration indication states; and
determine whether to apply the unified transmission configuration indication state to the at least one channel based at least in part on the one of the single unified transmission configuration indication state or the two unified transmission configuration indication states being indicated to the UE.

28. The apparatus of claim 21, wherein the one or more conditions comprise whether a single default beam is supported by the UE or a plurality of default beams are supported by the UE, wherein the at least one processor is further configured to:
determine whether to apply the unified transmission configuration indication state to the at least one channel based at least in part on the single default beam being supported by the UE or the plurality of default beams being supported by the UE.

29. The apparatus of claim 21, wherein the at least one processor is further configured to:
receive third control signaling indicating to enable the UE to use a plurality of default beams; and
determine to apply the plurality of default beams for the at least one channel based at least in part on the UE having received the third control signaling enabling the UE to use the plurality of default beams.

30. An apparatus for wireless communication at a network entity, comprising:
memory; and
at least one processor of a network entity, the at least one processor coupled with the memory, and the at least one processor configured to:
output first control signaling identifying a configuration for a user equipment (UE) to use to communicate, using single frequency network communications for at least one channel, with a first transmission reception point and a second transmission reception point associated with the network entity;
output second control signaling indicating that the UE is to use a unified transmission configuration indication state that identifies that a single beam at the UE is applicable to a plurality of channels, including the at least one channel; and
communicate on the at least one channel according to at least one beam based at least in part on determining, according to one or more conditions, whether the UE is to apply the unified transmission configuration indication state to the at least one channel.
